(19) United States
(12) Patent Application Publication
(10) Pub. No.: US 2015/0124686 A1
(43) Pub. Date: May 7, 2015

(54) ADAPTIVE BROADCAST MULTICAST SERVICE AREA AND ADAPTIVE SINGLE FREQUENCY NETWORK AREA

(71) Applicant: QUALCOMM Incorporated, San Diego, CA (US)

(72) Inventors: Xiaoxia ZHANG, San Diego, CA (US); Jun WANG, Poway, CA (US); Andrea GARAVAGLIA, Nuremberg (DE)

(21) Appl. No.: 14/509,028

(22) Filed: Oct. 7, 2014

Related U.S. Application Data
(60) Provisional application No. 61/900,910, filed on Nov. 6, 2013.

(51) Int. Cl. H04L 12/18; H04W 16/18; H04W 24/02; H04W 88/08

(52) U.S. Cl. CPC H04L 12/189; H04W 88/08; H04W 16/18; H04W 24/02
USPC 370/312

(57) ABSTRACT

A method, an apparatus, and a computer program product for wireless communication are provided. In one configuration, the apparatus receives at least one of UE count information or signal quality information from each of at least one base station. The UE count information includes a number of UEs that are interested in receiving MBMS services. The signal quality information includes MBSFN measurement information. The apparatus determines whether a base station should be part of a multicast broadcast service area based on the at least one of the UE count information or the signal quality information. The multicast broadcast service area may include one or more of an MBMS service area, an MBSFN area, an MTCH SFN, or an MCCH SFN. The apparatus sends to the base station information indicating whether the base station should be part of the multicast broadcast service area.

### CROSS-REFERENCE TO RELATED APPLICATION(S)

This application claims the benefit of U.S. Provisional Application Serial No. 61/900,910, entitled “Adaptive Broadcast Multicast Service Area and Adaptive Single Frequency Network Area” and filed on Nov. 6, 2013, which is expressly incorporated by reference herein in its entirety.

### BACKGROUND

1. Field

The present disclosure relates generally to communication systems, and more particularly, to an adaptive broadcast multicast service area and an adaptive Multicast Broadcast Single Frequency Network (MBSFN) area.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus receives at least one of user equipment (UE) count information or signal quality information from each of at least one base station. The UE count information includes a number of UEs that are interested in receiving an multimedia broadcast multicast services (MBMS) service. The signal quality information includes MBSFN measurement information. The apparatus determines whether a base station should be part of a multicast broadcast service area based on the at least one of the UE count information or the signal quality information. The apparatus sends to the base station information indicating whether the base station should be part of the multicast broadcast service area.

In an aspect of the disclosure, a method, a computer program product, and an apparatus are provided. The apparatus may be a UE. The UE sends at least one of UE count information or signal quality information to a serving base station. The UE count information indicates that the UE is interested in receiving the MBMS service. The signal quality information includes MBSFN measurement information. The signal quality information may further include unicast measurement information. The UE receives the MBMS service from one or more base stations based on the at least one of the UE count information or the signal quality information sent to a serving base station. The one or more base stations include at least one of the serving base station or one or more neighboring base stations.

The UE count information may be sent in a counting report or an MBMS interest indication message. The signal quality information may be with respect to serving base stations and neighboring base stations. The signal quality information may further include unicast measurement information. The unicast measurement information may be based on unicast transmissions, and the unicast measurement information may include at least one of reference signal received power information, reference signal received quality information, a receive strength signal indicator, a signal to noise ratio, or a signal to interference plus noise ratio. The MBSFN measurement information may be based on muilticast/broadcast transmissions, and the MBSFN measurement information may include at least one of MBSFN reference signal received power information, MBSFN reference signal received quality information, a MBSFN receive strength signal indicator, a MBSFN signal to noise ratio, or a MBSFN signal to interference plus noise ratio. The UE may receive a request for the UE count information. The UE count information may be sent in response to the request. The UE may receive at least one of a period or a threshold for indicating to the UE whether to send the at least one of the UE count information or the signal quality information. The at least one of the period or the threshold may be received by the UE through at least one of radio resource control signaling, a system information block, or a multicast control channel.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia

Broadcast Multicast Service channel configuration in a Multicast Broadcast Single Frequency Network.

FIG. 7B is a diagram illustrating a format of a Multicast Channel Scheduling

Information Media Access Control control element.

FIG. 8 is a first diagram for illustrating exemplary methods for adaptively configuring multicast broadcast service areas/MBSFN areas.

FIG. 9 is a second diagram for illustrating exemplary methods for adaptively configuring multicast broadcast service areas/MBSFN areas.

FIG. 10 is a third diagram for illustrating exemplary methods for adaptively configuring multicast broadcast service areas/MBSFN areas.

FIG. 11 is a fourth diagram for illustrating exemplary methods for adaptively configuring multicast broadcast service areas/MBSFN areas.

FIG. 12 is a fifth diagram for illustrating exemplary methods for adaptively configuring multicast broadcast service areas/MBSFN areas.

FIG. 13 is a diagram illustrating a first exemplary algorithm architecture.

FIG. 14 is a diagram illustrating a first exemplary signaling design for an adaptive MBSFN.

FIG. 15 is a diagram illustrating a second exemplary signaling design for an adaptive MBSFN.

FIG. 16 is a diagram illustrating a second exemplary algorithm architecture.

FIG. 17 is a diagram illustrating a third exemplary signaling design for an adaptive MBSFN.

FIG. 18 is a flow chart of a first method of wireless communication.

FIG. 19 is a flow chart of a second method of wireless communication.

FIG. 20 is a conceptual data flow diagram illustrating the data flow between different modules/means/components in an exemplary apparatus.

FIG. 21 is a diagram illustrating an example of a hardware implementation for an apparatus employing a processing system.

FIG. 22 is a conceptual data flow diagram illustrating the data flow between different modules/means/components in an exemplary apparatus.

FIG. 23 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

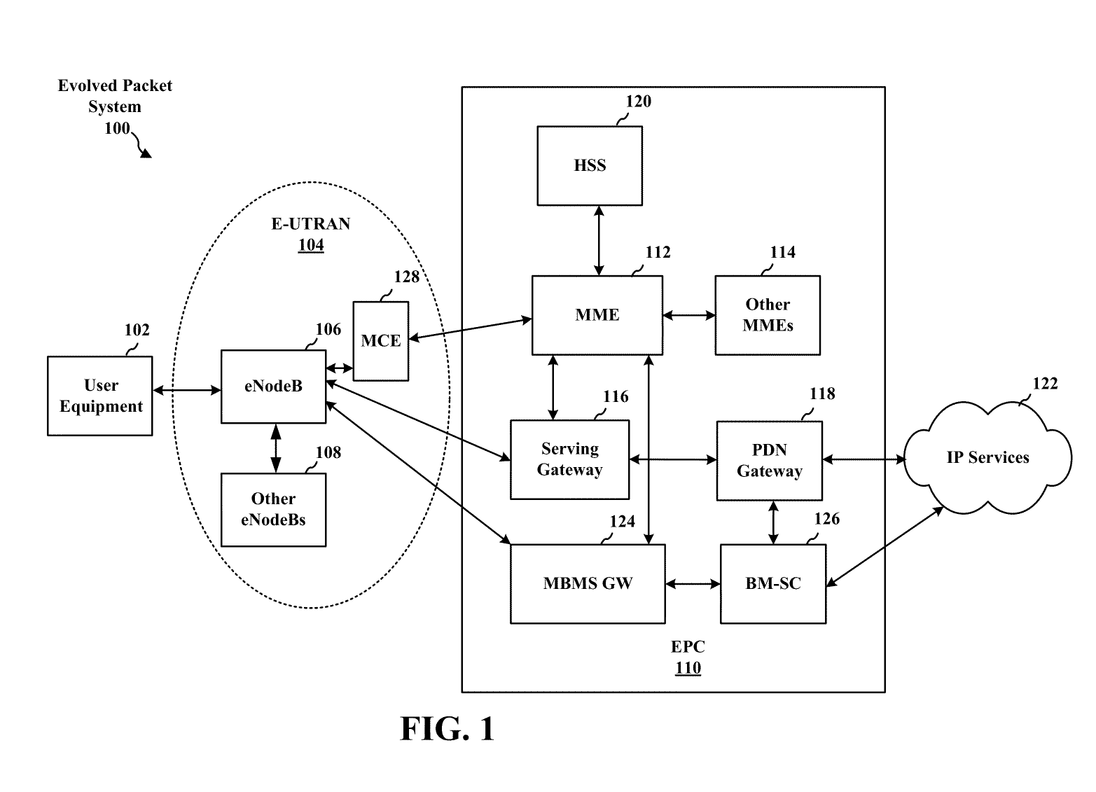

FIG. 1 is a diagram illustrating an LTE network architecture 100. The LTE network architecture 100 may be referred to as an Evolved Packet System (EPS) 100. The EPS 100 may include one or more UEs 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

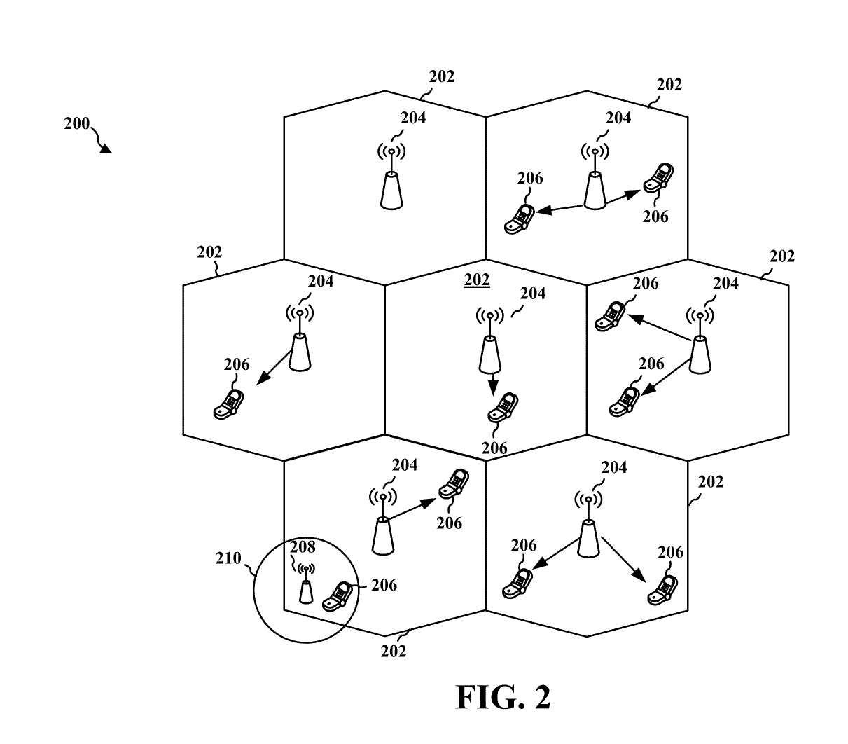

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

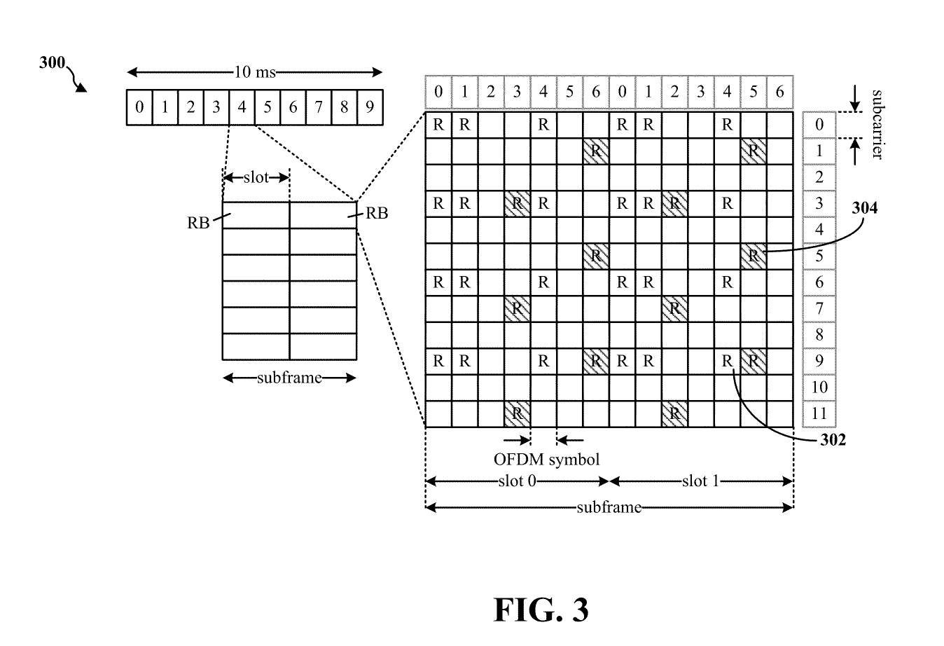

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

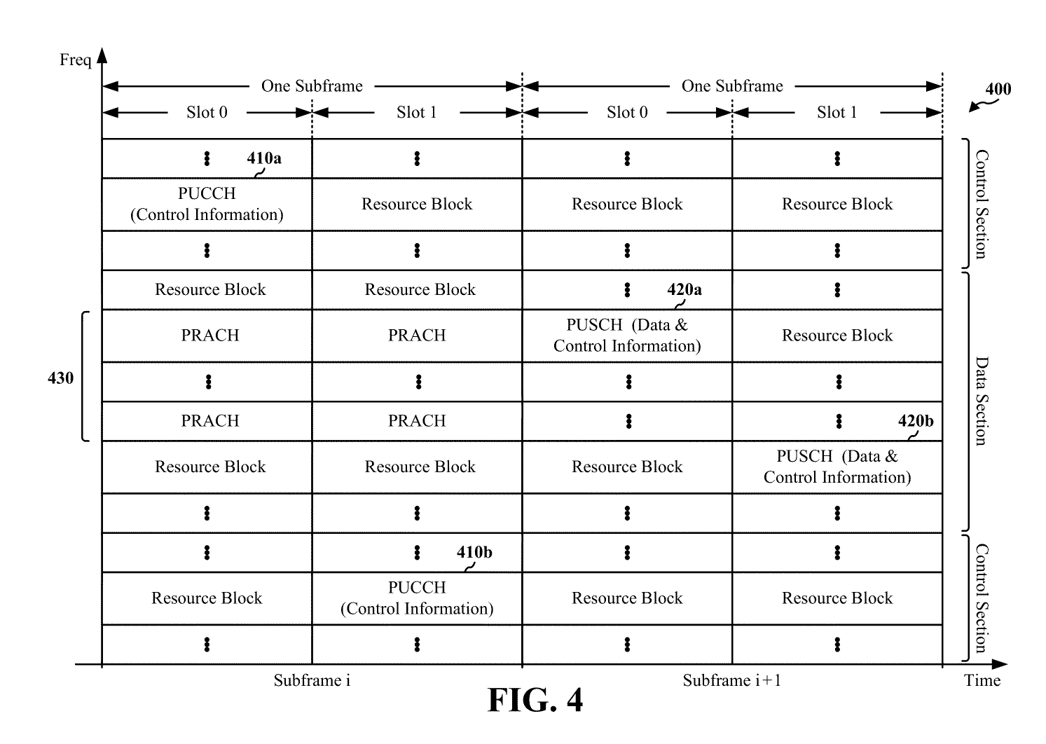

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

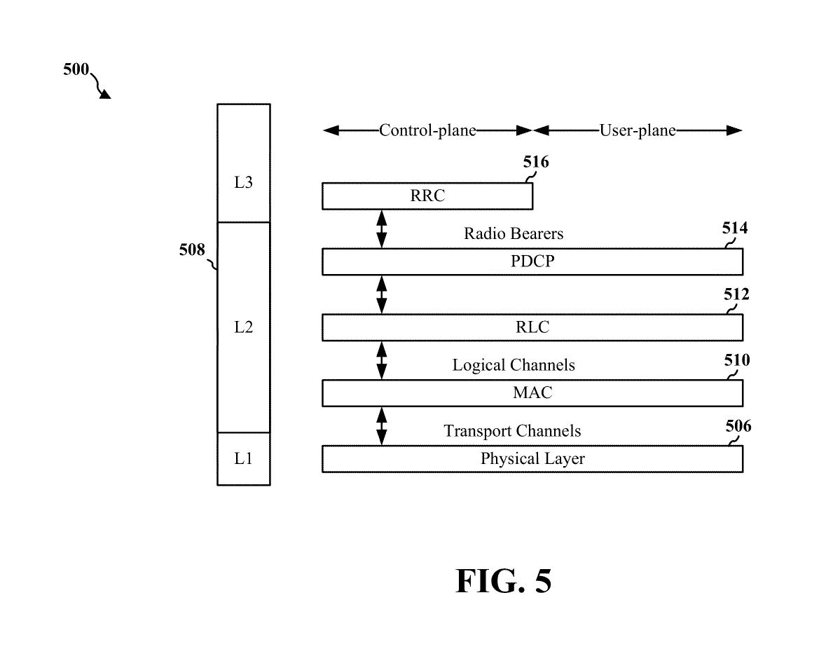

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

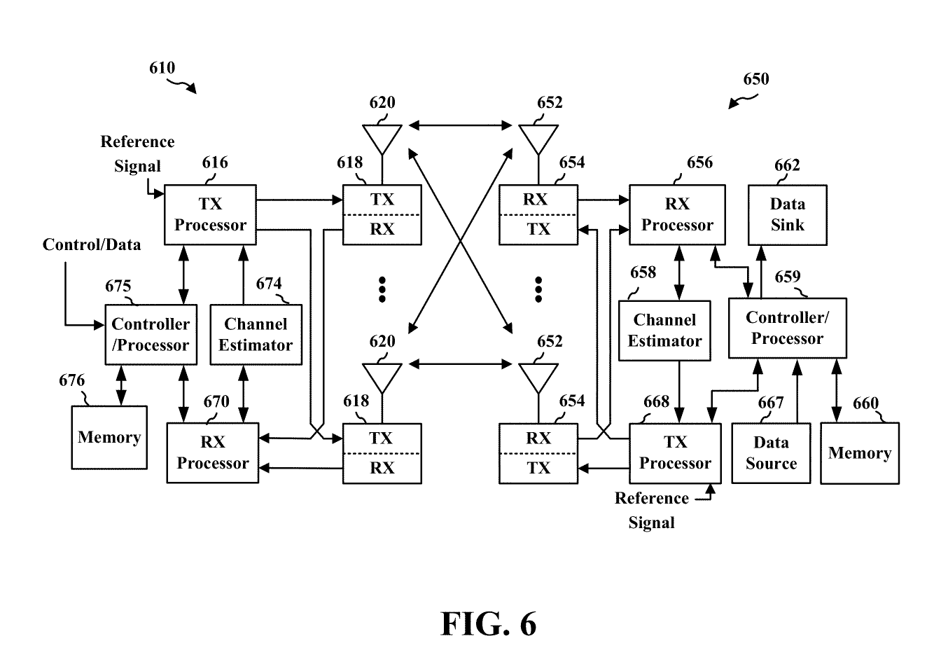

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

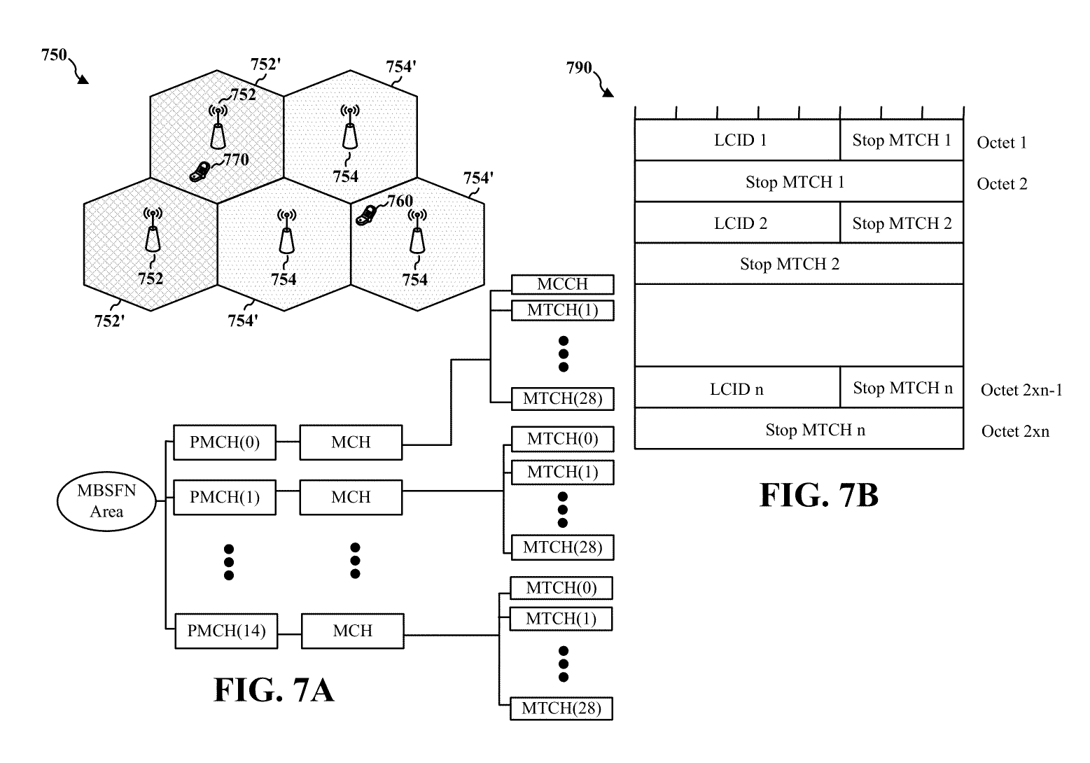

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports one or more physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a system information block (SIB) 13 (SIB13). Subsequently, based on the SIB13, the UE may acquire an MBSFN Area Configuration message on an MCCH. Subsequently, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

Currently, an MBMS service area (a collection of cells within a geographic area)/MBSFN area is static and may only be changed in a new operation and maintenance (O&M) configuration during a maintenance period. With an increase in eMBMS popularity, a dynamic service area and adaptive configuration of the MBMS service area/MBSFN area may be beneficial for improving system resource utilization and improving MBMS reception quality. An adaptive MBMS service area/MBSFN area may be utilized for eMBMS on demand in which the network forms the MBMS service area/MBSFN area dynamically if a large interest in the same service is identified. A network may form an MBMS service area/MBSFN area based on the location (e.g., global cell identifier (GCI) or global positioning system (GPS) based position) of UEs that are interested in the same service/content. An adaptive MBMS service area/MBSFN area may be utilized for Group Communication System Enablers (GCSE) for LTE. As UEs move within the network, cells may be removed and/or added to a MBMS service area/MBSFN area to facilitate the communication. Adaptive MBMS service areas/MBSFN areas are discussed further infra.

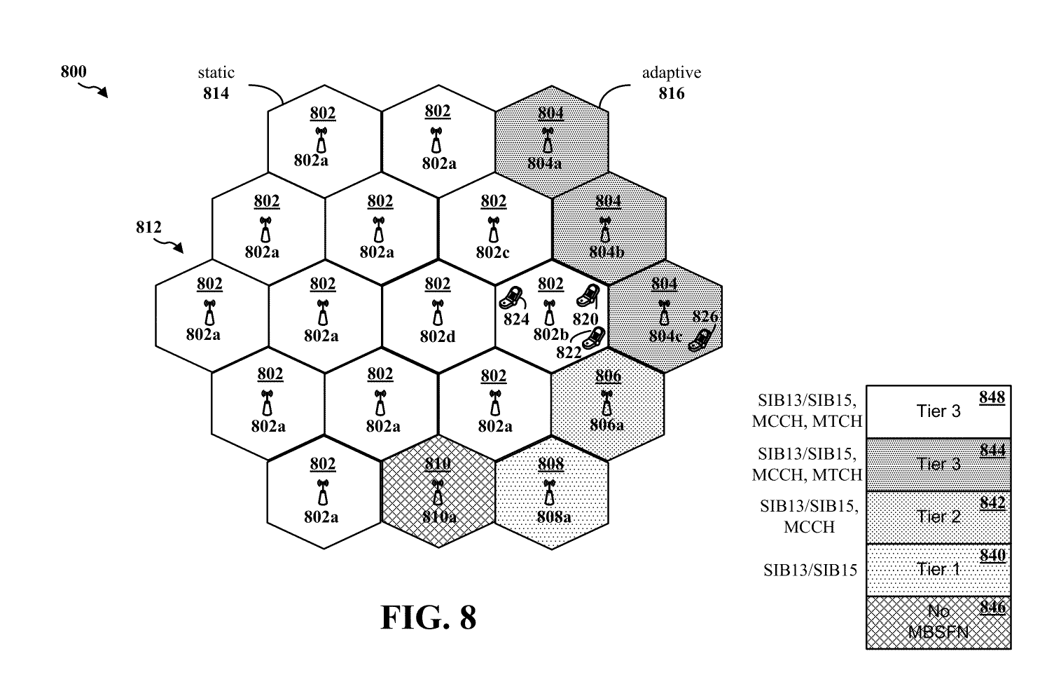

FIG. 8 is a first diagram 800 for illustrating exemplary methods for adaptively configuring multicast broadcast service areas. Herein, a “multicast broadcast service area” includes at least one of an MBMS service area, an MBSFN area, an MTCH Single Frequency Network (SFN), or an MCCH SFN. An SFN is a broadcast network in which eNBs in the network simultaneously transmit the same signal over the same frequency channel. Accordingly, an MTCH SFN is a broadcast network in which eNBs in the network simultaneously transmit the same MTCH over the same frequency channel, and an MCCH SFN is a broadcast network in which eNBs in the network simultaneously transmit the same MCCH over the same frequency channel. A “dynamic/adaptively configurable multicast broadcast service area” may refer to at least one of (1) a dynamic/adaptively configurable MBMS service area in which a collection of cells associated with a particular geographic area may change; (2) a dynamic/adaptively configurable MBSFN area in which one or more cells may be added to or remove from the MBSFN area (the MBSFN area is within the defined MBMS service area); (3) a dynamic/adaptively configurable MTCH SFN in which one or more cells may be configured to provide or not to provide the same MTCH (see reference to tiers infra); or (4) a dynamic/adaptively configurable MCCH SFN in which one or more cells may be configured to provide or not to provide the same MCCH (see reference to tiers infra).

Referring to FIG. 8, a multicast broadcast synchronization area 812 (also referred to as MBMS synchronization area), which is an area of the network where all eNBs can be synchronized and perform MBSFN transmissions, may include cells 802, 804, 806, 808, 810 corresponding to the eNBs 802a, 802b, 802c, 802d, 804a, 804b, 804c, 806a, 808a, and 810a. One or more of the eNBs within the multicast broadcast synchronization area 812 may determine one or more of a number of UEs, served by the eNBs, that are interested in receiving an MBMS service; a number of UEs interested in receiving an MBMS service as indicated in received MBMS interest indication messages; MBSFN measurement information (also referred to as multicast/broadcast signal quality information) as indicated in multicast/broadcast signal quality reports from UEs receiving an MBMS service; and/or unicast measurement information (also referred to as unicast signal quality information) as indicated in unicast signal quality reports. Herein, UE count information refers to at least one of the number of UEs, served by the eNBs, that has an interest in receiving an MBMS service, or the number of UEs interested in receiving an MBMS service as indicated in received MBMS interest indication messages. Each of the one or more of the eNBs may then send the determined information to a network entity, such as an MCE (e.g., 128 of FIG. 1) or a BM-SC (e.g., 126 of FIG. 1). An eNB may receive the unicast measurement information from UEs served by the eNB. An eNB may receive the MBSFN measurement information from UEs receiving an MBMS service transmitted by the eNB. For example, the eNB 802b may receive signal quality information from each of the UEs 820, 822, 824. The signal quality information may be with respect to unicast transmissions and/or multicast/broadcast transmissions and may include at least one of reference signal received power (RSRP) information, reference signal received quality (RSRQ) information, a receive strength signal indicator (RSSI), a signal to noise ratio (SNR), or a signal to interference plus noise ratio (SINR). The unicast signal quality information may be with respect to the serving base station and neighboring base stations. The MBSFN signal quality information is the combination of eNBs within MBSFN. Accordingly, the eNB 802b may receive signal quality information from the UE 820 based on unicast and/or multicast/broadcast transmissions from the eNBs 802b, 804b, 804c; from the UE 822 based on unicast and/or multicast/broadcast transmissions from the eNBs 802b, 804c, 806a; and/or from the UE 824 based on unicast and/or multicast/broadcast transmissions from the eNBs 802b, 802c, 802d. Each of the one or more of the eNBs then sends the respective received signal quality information to the network entity, such as the MCE or the BM-SC.

Based on one or more of the UE count information (i.e., a number of UEs interested in receiving an MBMS service) and the signal quality information (i.e., MBSFN measurement information and/or unicast measurement information), the MCE or BM-SC determines whether an eNB should be part of the MBMS service area (which can include one or more multicast broadcast synchronization areas), and furthermore whether the eNB should be part of an MBSFN area within the multicast broadcast synchronization area 812. For example, upon receiving one or more of the UE count information and the signal quality information, the MCE or BM-SC may determine that the eNB 804c should be part of the MBMS service area and/or be a part of an MBSFN area within the multicast broadcast synchronization area 812. The MCE or BM-SC may make such a determination based on providing an improved MBSFN transmission or improved MBMS service for a UE served by the eNB 804c, such as the UE 826; based on providing an improved MBSFN (MBMS) service for any UEs served by the eNB 802b, such as the UEs 820, 822, 824; or based on providing an improved (e.g., improved MBSFN RSRP, MBSFN RSRQ, MBSFN RSSI, MBSFN SNR, MBSFN SINR) MBSFN transmission or MBMS service for any UEs on the cell edge of the eNB 804c, such as for the UEs 820, 822. Specifically, the MCE or BM-SC may determine that a sufficient number of UEs within the coverage of the eNB 804c, such as the UE 826, would like to receive an MBSFN transmission or MBMS service from the eNB 804c; that a sufficient number of UEs within the coverage of the eNB 802b, such as the UEs 820, 822, 824, are reporting that a multicast/broadcast signal quality of a received MBMS service is less than a threshold; or that a sufficient number of UEs within the coverage of the eNB 802b are located on a cell edge of the eNB 804c, such as the UEs 820, 822. Based on such a determination, the MCS or BM-SC may determine that the eNB 804c should be part of the MBMS service area and/or be a part of an MBSFN area within the multicast broadcast synchronization area 812.

As shown in FIG. 8, the cells 802 (the static set of cells 814) within the multicast broadcast synchronization area 812 are statically configured and therefore the MBMS service area configuration and the MBSFN area of each of the cells 802 may not be adaptively configured or dynamically changed. However, the cells 804, 806, 808, 810 (the adaptive set of cells 816) within the multicast broadcast synchronization area 812 may be adaptively configurable and therefore the MBMS service area configuration and/or the MBSFN area of each of the cells 804, 806, 808, 810 may be adaptively configured or dynamically changed. Note that the static set of cells initially in an MBSFN area can include zero or more cells. Upon receiving one or more of the UE count information and the signal quality information, the MCE or BM-SC may form an MBSFN area or rank the adaptively configurable eNBs based on the received information. For example, the MCE or BM-SC may rank an adaptively configurable eNB higher if the adaptively configurable eNB serves a sufficient number of UEs that would like to receive an MBSFN transmission or MBMS service and/or would improve the signal quality of a sufficient number of UEs on a cell edge of the adaptively configurable eNB or within a cell at the edge of an MBSFN area. In one configuration, the eNBs within the multicast broadcast synchronization area 812 perform the ranking and send ranked list information to the MCE or BM-SC. The ranked list information includes a list of the adaptively configurable eNBs ranked based on which of the adaptively configurable eNBs would have the most impact to UEs (e.g., providing MBMS services, improving signal quality to cell edge UEs, etc.) if configured to be part of the multicast broadcast service area. Based on the ranked adaptively configurable eNBs, the MCE or BM-SC determines which eNBs should be part of the MBMS service area and/or part of particular MBSFN areas. The MCE or BM-SC then sends information to the adaptively configurable eNBs indicating which ones of the adaptively configurable eNBs should be part of the MBMS service area and/or particular MBSFN areas.

The MCE or BM-SC may also determine a broadcasting tier for the adaptively configurable eNB upon determining the adaptively configurable eNB should be part of the MBMS service area and/or particular MBSFN areas. The determined broadcasting tier may be a first tier (tier 1) 840 for broadcasting a SIB (e.g., SIB13) indicating an MCCH configuration for the MCCH and/or a SIB (e.g., SIB15) for indicating service area identities (SAIs); a second tier (tier 2) 842 for broadcasting the SIB13/SIB15 and broadcasting the MCCH indicating an MTCH configuration; or a third tier (tier 3) 844 for broadcasting the SIB13/SIB15, broadcasting the MCCH indicating the MTCH configuration, and broadcasting the MTCH. The SIB15 indicates the SAIs that are available at a current frequency (the frequency on which the SIB15 is broadcast) and at neighboring frequencies. Based on a received user service description (USD) and a SIB15, a UE may be able to determine MBMS services that the UE can receive from the eNBs. When a UE is interested in an MBMS service available on one of the frequencies associated with the indicated SAIs, the UE may send an MBMS interest indication message to indicate such interest to a serving eNB. The serving eNB may then hand over the UE to a cell operating at the frequency of interest.

The use of broadcasting tiers allows for particular adaptively configurable eNBs to be configured to provide different levels of MBSFN transmissions. For example, if an adaptively configurable eNB serves many UEs interested in receiving an MBMS service or the broadcasting of the MTCH by the eNB would improve a quality of an MBMS service received by UEs served by other eNBs, the adaptively configurable eNB may be configured in broadcasting tier 3. However, if the adaptively configurable eNB serves few or no UEs and the broadcasting of the MTCH by the eNB would provide no to little improvement to signal reception by cell edge UEs served by other eNBs, the adaptively configurable eNB may be configured in broadcasting tier 2 or broadcasting tier 1. As shown in FIG. 8, the static eNBs are configured with broadcasting tier 3 (848). Further, as shown in FIG. 8, based on the UE count information and the signal quality information, the MCE or BM-SC determined that the adaptively configurable eNBs 804a, 804b, 804c should provide broadcasting tier 3 844 MBSFN service support (as shown, tier 3 also includes eNBs 802), the adaptively configurable eNB 806a should provide broadcasting tier 2 842 MBSFN service support, the adaptively configurable eNB 808a should provide broadcasting tier 1 840 MBSFN service support, and the adaptively configurable eNB 810a should be a reserved cell or should not be a part of the MBMS service area and/or provide MBSFN services (846). Upon determining the broadcasting tier for the adaptively configurable eNBs, the MCE or BM-SC sends information to the eNBs indicating each eNB's respective MBSFN broadcasting tier.

When an adaptively configurable eNB may be configured between providing tier 2 and tier 3 services, the eNB is within a dynamic/adaptively configurable MTCH SFN. When an adaptively configurable eNB may be configured between providing tier 1 and tier 2 services, the eNB is within a dynamic/adaptively configurable MCCH SFN. As discussed supra, a dynamic/adaptively configurable multicast broadcast service area includes a dynamic/adaptively configurable MBMS service area, MBSFN area, MTCH SFN, and/or MCCH SFN.

When the MCE/BM-SC determines that an adaptively configurable eNB should not provide MBMS services in the multicast broadcast synchronization area 812, the multicast broadcast service area decreases in size. When the MCE/BM-SC determines that an adaptively configurable eNB should provide MBMS services in the multicast broadcast synchronization area 812, the multicast broadcast service area increases in size. As such, the determination of whether adaptively configurable eNBs should provide or not provide MBMS services in the multicast broadcast synchronization area 812 may ultimately change the size of the multicast broadcast service area, usually on the edges of the multicast broadcast synchronization area 812. As discussed supra, each eNB may support up to eight MBSFN areas. When the MCE/BM-SC determines that an adaptively configurable eNB should not be a part of an MBSFN area of the multicast broadcast synchronization area 812, the multicast broadcast synchronization area 812 does not change in size. Instead, the services provided by one of the cells in the multicast broadcast synchronization area 812 changes. The adaptive multicast broadcast service area allows for areas associated with MBSFN/MBMS services to change based on UE mobility, UE multicast broadcast service interest, multicast broadcast reception quality improvement, etc.

The multicast broadcast service area includes the cells that provide various levels of MBSFN services, such as broadcasting tier 1, broadcasting tier 2, and broadcasting tier 3 support. For example, referring to FIG. 8, the cells 802 are initially part of the multicast broadcast service area. After the adaptive configuration, the cells 802, 804, 806, 808 are part of the multicast broadcast service area. The cell 810 is not part of the multicast broadcast service area because the cell 810 is not participating in the MBSFN transmission. In a first configuration, an MBSFN area may include the cells that provide the same MTCH and MCCH for that MBSFN area (e.g., broadcasting tier 2 and broadcasting tier 3). In a second configuration, the MBSFN area may include cells that provide the same MTCH, MCCH, and SIB13/SIB15 for the MBSFN area (e.g., broadcasting tiers 1, 2, and 3). Accordingly, in the first configuration, after the adaptive configuration, the cells 802, 804, 806 are part of the MBSFN area. The cells 808, 810 are not part of the MBSFN area, as they are not providing MCCH or MTCH. However, in the second configuration, the cell 808 may be part of the MBSFN area even though the cell is not providing the MTCH and MCCH. In the tiered deployment, the MCE may send a counting request or an MBSFN measurement request over the MCCH on tier 2. Upon receiving counting information or an MBSFN measurement report, based on the number of UEs and optionally the locations of UEs in the tier 2 area, the MCE or BM-SC may decide the size of tier 3, which can be the same or smaller than tier 2. By doing this, within MBSFN adaptive areas, a group of cells that may only send SIB13/15 (tier 1), or send both SIB13/SIB15 and MCCH without sending MTCH (tier 2) can use the resources for unicast service if no UE's within the tier 3 area are interested in the MBMS services, therefore it allows better radio resource utilization. Another benefit of tiered deployment is to simplify pico, femto, and relay implementation by only supporting SIB13/15 or only MCCH without supporting MTCH.

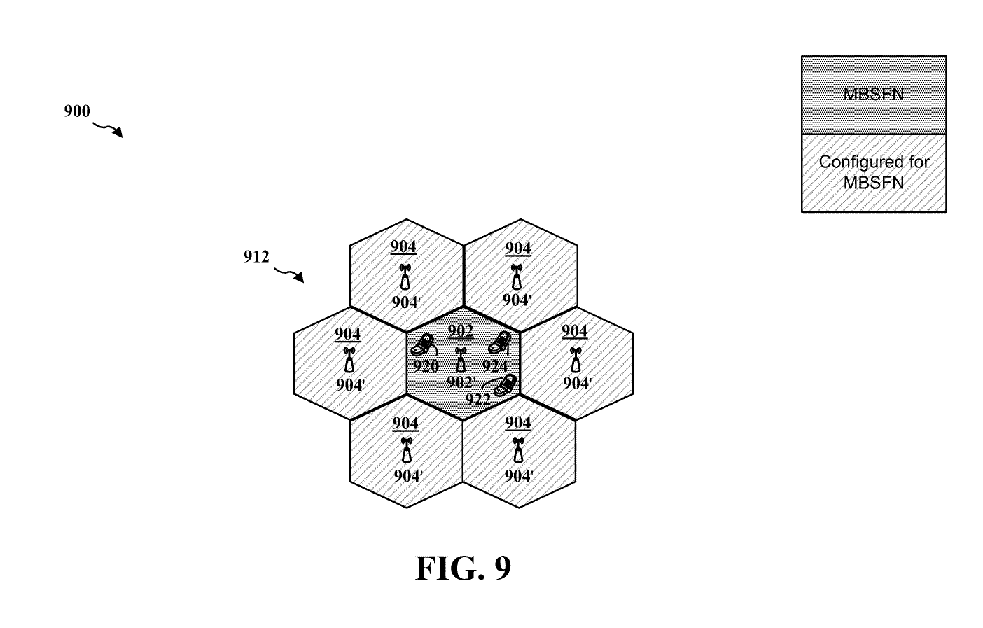

FIG. 9 is a second diagram 900 for illustrating exemplary methods for adaptively configuring multicast broadcast service areas. As shown in FIG. 9, a multicast broadcast synchronization area 912 may include cells 902, 904 corresponding to the eNBs 902′, 904′, respectively. The UEs 920, 922, 924 are within the coverage of the eNB 902′. In one configuration, MBMS service areas/MBSFN areas may be adaptively configured based on UE count information received in counting reports. The UE count information may indicate a number of UEs that are in an RRC connected mode/state within a cell that have an interest in receiving an MBMS service. For example, assume the cell 902 is configured as an MBMS service area within the multicast broadcast synchronization area 912 and that the cell 902 is configured with a particular MBSFN area. Assume also that the cells 904 are not configured to be part of the MBMS service area (e.g., are reserved cells), or are configured to be a part of the MBMS service area (e.g., they provide MBMS services), but with a different MBSFN area. A network entity such as a BM-SC or an MCE may send a counting request (e.g., through eNBs and the MCCH) to a UE requesting a counting response, and receive the counting response (e.g., from eNBs that receive the counting response from UEs through a unicast channel) including the UE count information for the cell 902. The network entity compares the number of UEs indicated by the UE count information to a threshold. If the number of UEs with an interest in receiving an MBMS service and in an RRC connected mode within the cell 902 is greater than a threshold, the network entity may configure the surrounding cells 904 to be a part of the same MBSFN area as the cell 902. When the number of UEs with an interest in receiving an MBMS service and in an RRC connected mode with the cell 902 is greater than the threshold, the network entity may determine that there are enough UEs within the cell 902 that may benefit from the additional surrounding cells 904 providing the same MBMS services, especially UEs on the cell edge, such as the UEs 920, 922, 924.

Accordingly, if the cell 902 belongs to MBSFN area 1, the cells 904 may be configured to provide MBMS services associated with the MBSFN area 1 if the network entity determines that a sufficient number of UEs in coverage of the cell 902 may benefit from the surrounding cells 904 providing services associated with the MBSFN area 1. If the surrounding cells 904 are not already providing MBMS services, the surrounding cells may be configured to be within the same MBMS service area as the cell 902 and to be within the MBSFN area 1. If the surrounding cells 904 are already providing MBMS services, the surrounding cells may be configured to be within the MBSFN area 1. Assuming a cell may provide MBMS services for only eight MBSFN areas, the network entity may need to determine to remove a particular MBSFN area from the surrounding cells 904 if they are already providing MBMS services for eight MBSFN areas.

The network entity, such as the MCE, may recognize the cell identifiers (IDs) from each counting report received from the eNB 902′. The network entity may turn on a cell's neighbor for MBSFN if enough UEs are reported in that cell. UEs may send counting reports upon receiving a counting request. The counting request may be received through the MCCH. UEs may send the counting report through a unicast channel. The network entity may send updated counting requests after reshaping an MBSFN area to cover potential UEs in non-MBSFN cells. UEs may indicate a UE ID and/or a cell ID in the counting report. The UE ID allows the network entity to link received information (e.g., counting report, MBMS interest indication report, MBSFN measurement report, unicast measurement report) together from a particular UE. Alternatively, the eNB 902′ may process the received counting reports and include a UE ID and/or a cell ID within the counting reports provided to the network entity.

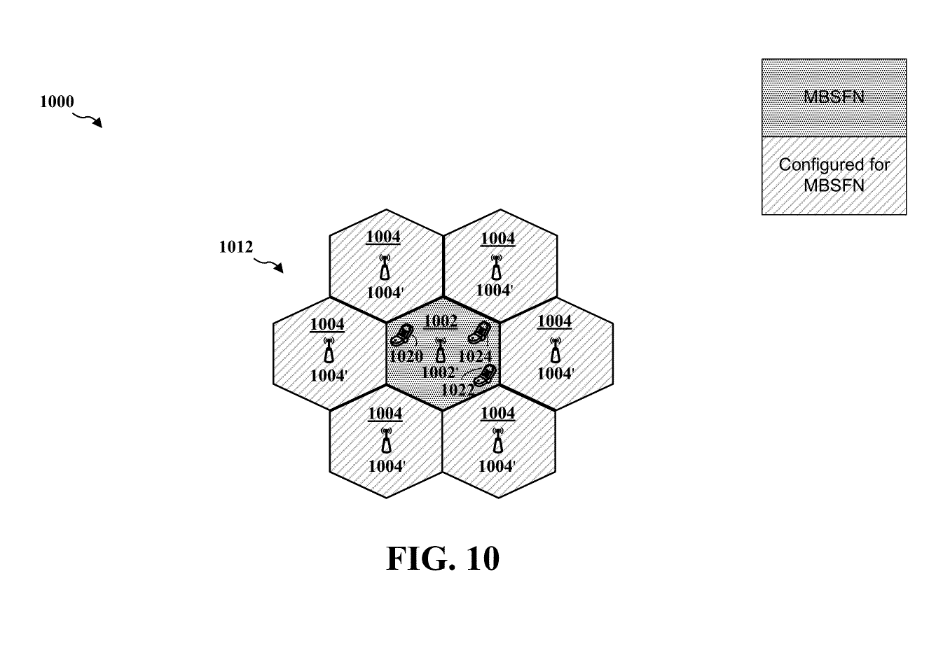

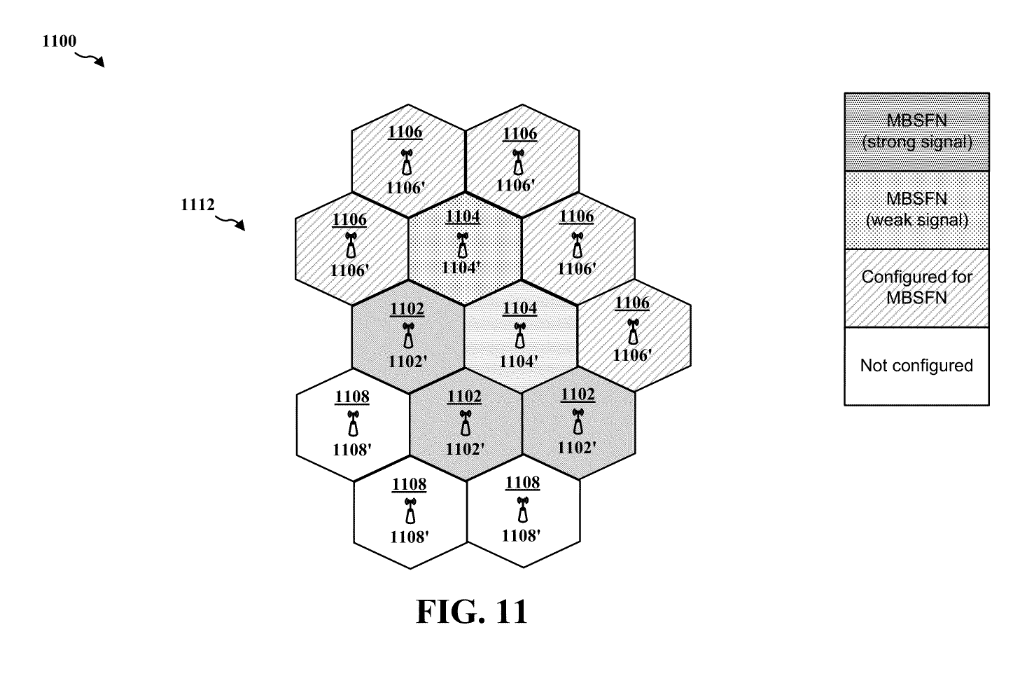

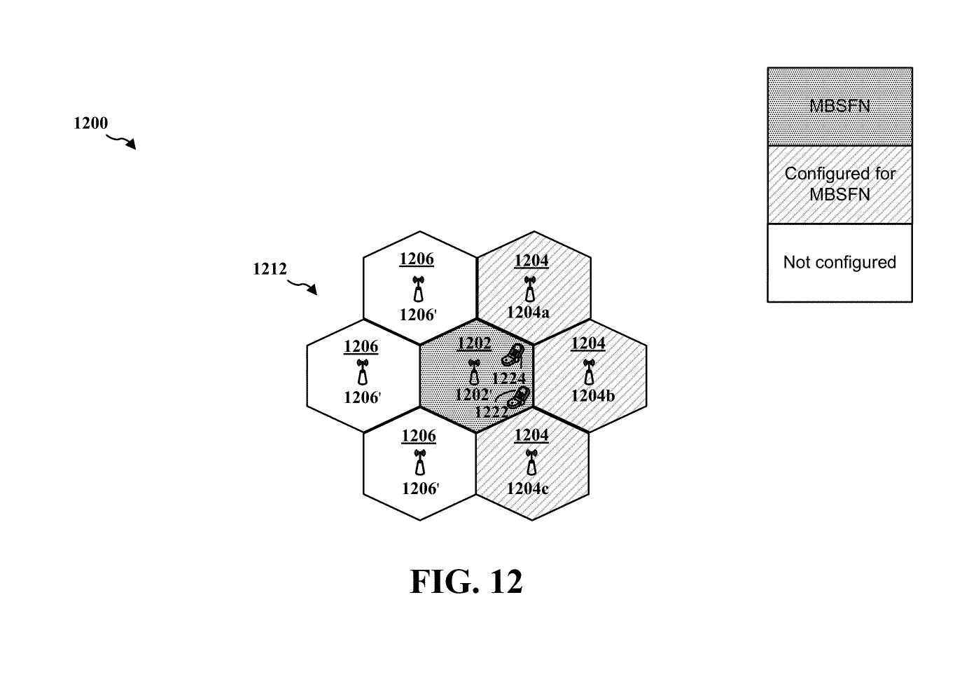

The counting reports may not indicate a UE's location and thus a network entity may turn on neighbor cells unnecessarily. For example, if all UEs are close to the eNB 902′, turning on neighbor cells may be unnecessary. Further, if the counting request is received through the MCCH, the counting response may only be applicable when the UE is already in the MBSFN area. For example, UEs within the coverage of the eNBs 904′ and outside the coverage of the eNB 902′ may not send counting reports because the eNBs do not transmit the MCCH. Lastly, because UEs must be in a connected mode to send the counting reports, the UE count information may indicate only the number of UEs in an RRC connected state and not the number of UEs in an RRC idle state. As such, the UE count information may not be a great gauge of the number of UEs (or the best for determining the number of UEs) that could benefit from an improved quality of MBMS services. Accordingly, additional or alternative information may be provided to the network entity to allow the network entity to determine which cells to adaptively configure for multicast broadcast service areas. The additional or alternative information includes a number of UEs that have indicated an interest in receiving MBMS services through MBMS interest indication messages (see FIG. 10), MBSFN measurement information (see FIG. 11), and unicast measurement information (see FIG. 12).

FIG. 10 is a third diagram 1000 for illustrating exemplary methods for adaptively configuring multicast broadcast service areas. As shown in FIG. 10, a multicast broadcast synchronization area 1012 may include cells 1002, 1004 corresponding to the eNBs 1002′, 1004′, respectively. The UEs 1020, 1022, 1024 are within the coverage of the eNB 1002′. In one configuration, MBMS service areas/MBSFN areas may be adaptively configured based on UE count information determined from a number of UEs in the cell that have indicated an interest in receiving an MBMS services (or particular MBMS services) in MBMS interest indication messages. For example, assume the cell 1002 is configured as an MBMS service area within the multicast broadcast synchronization area 1012 and that the cell 1002 is configured with a particular MBSFN area. Assume also that the cells 1004 are not configured to be part of the MBMS service area (e.g., are reserved cells), or are configured to be a part of the MBMS service area (e.g., they provide MBMS services), but with a different MBSFN area. A network entity such as a BM-SC or an MCE may receive the MBMS interest indication information for the cell 1002, and compare the number of UEs that have indicated an interest in receiving MBMS services to a threshold. If the number of UEs that have indicated an interest in receiving MBMS services is greater than a threshold, the network entity may configure the surrounding cells 1004 to be a part of the same MBSFN area as the cell 1002. Additionally or alternatively, when the number of UEs that have indicated an interest in receiving MBMS services is greater than the threshold, the network entity may determine that there are enough UEs within the cell 1002 that may benefit from the additional surrounding cells 1004 providing the same MBMS services, especially UEs on the cell edge, such as the UEs 1020, 1022, 1024.

The MBMS interest indication information may be received by eNBs not currently providing MBMS services. In another example, a network entity such as a BM-SC or an MCE may receive the MBMS interest indication information for the cells 1004. The MBMS interest indication information may indicate a preference to receive MBMS services from a particular MBSFN area. The network entity may compare the number of UEs that have indicated an interest in receiving MBMS services to a threshold. If the number of UEs that have indicated an interest in receiving MBMS services is greater than a threshold, the network entity may configure the eNBs 1004′ to be a part of the particular MBSFN area. When the number of UEs that have indicated an interest in receiving MBMS services is greater than the threshold, the network entity may determine that there are enough UEs within the cell 1004 that may benefit from the cells 1004 providing the MBMS services associated with the particular MBSFN area.

The MBMS interest indication message may indicate a frequency of interest. As such, the network entity may determine a number of UEs interested in receiving MBMS services for each of a plurality of frequencies. When the number of UEs is greater than a threshold for a frequency, the network entity may configure the eNBs 1004′ to belong to the MBSFN area corresponding to the frequency. For intra-frequency, the eNBs 1004′ may determine to participate in the MBSFN and initiate an M2 step with the network entity (e.g., the MCE). For inter-frequency, the eNB 1002′ may indicate the neighbor cells 1004 for MBSFN setup via X2. UEs may indicate a UE ID and/or a cell ID in the MBMS interest indication message. The UE ID allows the network entity to link received information (e.g., counting report, MBMS interest indication report, MBSFN measurement report, unicast measurement report) together from a particular UE. Alternatively, the eNBs may process the received MBMS interest indication messages and include a UE ID and/or a cell ID within the report of the MBMS interest indication messages provided to the network entity. MBMS interest indication messages can be sent by UEs in an RRC connected state/mode in non-MBMS cells assuming that the eNB supports service continuity via SIB 15.

FIG. 11 is a fourth diagram 1100 for illustrating exemplary methods for adaptively configuring multicast broadcast service areas. As shown in FIG. 11, a multicast broadcast synchronization area 1112 may include cells 1102, 1104, 1106 corresponding to the eNBs 1102′, 1104′, 1106′, respectively. In one configuration, MBMS service areas/MBSFN areas may be adaptively configured based on MBSFN measurements (also referred to as multicast/broadcast signal quality information) received from UEs receiving MBMS services. For example, assume the cells 1102, 1104 are configured as an MBMS service area within the multicast broadcast synchronization area 1112 and that the cells 1102, 1104 are configured with a particular MBSFN area. Assume also that UEs within the cells 1102 receive a stronger MBSFN signal and that UEs within the cells 1104 receive a weaker MBSFN signal. Further, assume that the cells 1106, 1108 are not currently associated with the particular MBSFN area (e.g., reserved cells, or MBSFN cells associated with one or more other MBSFN areas). UEs within the cells 1102, 1104 receive MBMS services and determine an MBSFN RSRP, MBSFN RSRQ, MBSFN RSSI, MBSFN SNR, and/or MBSFN SINR associated with the received MBMS services. The UEs send MBSFN measurement reports back to their serving eNBs reporting the MBSFN measurements. The eNBs 1102′, 1104′ may provide the MBSFN measurement reports to a network entity, such as an MCE or BM-SC. The network entity may determine that MBSFN signals in the cells 1104 are less than a threshold, and therefore that UEs within the coverage of the cells 1104 may benefit from neighbor cells 1106 broadcasting the same MBSFN signals. Further, the network entity may determine that MBSFN signals in the cells 1102 are greater than the threshold, and therefore that UEs within the coverage of the cells 1102 may not benefit sufficiently from neighbor cells 1108 broadcasting the same MBSFN signals. Accordingly, the network entity may configure the eNBs 1106′ to belong to the same MBSFN area as the eNBs 1104′.

The MBSFN measurement report may include the associated cell ID and the MBSFN area ID. The cell ID corresponding to the serving cell/camped cell where MBSFN measurements are performed. The MBSFN area ID corresponds to the MBSFN area where MBSFN measurements are performed. The network entity can turn on one cell's neighbor for MBSFN if enough UEs report MBSFN measurements associated with that cell and they do not experience a sufficient MBSFN signal quality. Accordingly, the network entity may determine whether to adaptively configure multicast broadcast service areas based on the MBSFN measurements in the MBSFN measurement reports and on the number of MBSFN measurement reports received. If the number of MBSFN measurement reports is greater than a first threshold and an average, median, or other metric of the MBSFN measurements is less than a second threshold, the network entity may configure neighbor cells to be within particular multicast broadcast service areas in order to improve the MBSFN signal quality of the UEs reporting insufficient MBSFN signal quality. In one configuration, if sufficient statistics on MBSFN measurements are collected, the network entity can potentially optimize the MBSFN area by reducing the MBSFN area size. UEs may indicate a UE ID in the MBSFN measurement reports. The UE ID allows the network entity to link received information (e.g., counting report, MBMS interest indication report, MBSFN measurement report, unicast measurement report) together from a particular UE. Alternatively, the eNBs may process the received MBSFN measurement reports to indicate the UE IDs.

FIG. 12 is a fifth diagram 1200 for illustrating exemplary methods for adaptively configuring multicast broadcast service areas. As shown in FIG. 12, a multicast broadcast synchronization area 1212 may include cells 1202, 1204, 1206 corresponding to the eNBs 1202′, 1204a, 1204b, 1204c, 1206′. In one configuration, MBMS service areas/MBSFN areas may be adaptively configured based on unicast measurements (also referred to as unicast signal quality information) received from UEs. For example, assume the cell 1202 is configured as an MBMS service area within the multicast broadcast synchronization area 1212 and that the cell 1202 is configured with a particular MBSFN area. Further, assume that the cells 1204, 1206 are not currently associated with the particular MBSFN area (e.g., reserved cells, or MBSFN cells associated with one or more other MBSFN areas). The UEs 1222, 1224 within the cell 1202 determine an RSRP, RSRQ, RSSI, SNR, and/or SINR of received reference/pilot signals received from the eNB 1202′ and neighboring eNBs, and report the unicast signal quality information to the eNB 1202′. The UE 1224 may provide unicast signal quality information associated with the eNBs 1202′, 1204a, 1204b; and the UE 1222 may provide unicast signal quality information associated with the eNBs 1202′, 1204b, 1204c. The eNB 1202′ may provide the unicast signal quality information to a network entity, such as an MCE or BM-SC. The network entity may determine a number of UEs that are on the cell edge based on the unicast signal quality information. The network entity may compare the unicast signal quality for the serving eNB and neighbor eNBs to one or more thresholds to determine whether the UEs are on the cell edge and what are the corresponding neighbor cells. For example, the network entity may determine that the UE 1224 is on the cell edge if the unicast signal quality from the eNB 1202′ is less than a first threshold, and if the unicast signal quality from the eNBs 1204a, 1204b is greater than a second threshold. In addition, the network entity may determine that the UE 1222 is on the cell edge if the unicast signal quality from the eNB 1202′ is less than a first threshold, and if the unicast signal quality from either of the eNBs 1204b, 1204c is greater than a second threshold. Having determined that UEs are located on the cell edge of the cells 1204, the network entity may then determine to adaptively configure the eNBs 1204a, 1204b, 1204c to be associated with the MBSFN area. Further, having determined that no UEs are located on the cell edge of the cells 1206, the network entity may determine not to adaptively configure the eNBs 1206′.

As discussed supra, multicast broadcast service areas may be adaptively configured based on UE count information (which includes one or more of a number of UEs being served by the corresponding eNBs that are interested in receiving MBMS services, or a number of UEs reporting an interest in receiving MBMS services in MBMS interest indication messages), MBSFN measurement reports, and unicast measurement reports. The information may be combined to obtain a better estimate of the UEs that can benefit from a particular configuration for the multicast broadcast service areas. Unicast signal quality information allows differentiating specific neighbor cells for MBSFN participation based on UE location. The unicast signal quality information can indicate whether the UE is located in the center or the edge of a cell. The unicast signal quality information can further indicate the neighbor cells that are close. Accordingly, with UE count information combined with unicast signal quality information, multicast broadcast service areas may be adjusted if there are a sufficient number of UEs on the cell edge that may benefit from the adjustment. With MBSFN and unicast signal quality information, multicast broadcast service areas may be adjusted if there are a sufficient number of UEs close to the cells providing an insufficient MBSFN signal quality.

The counting reports/MBSFN measurement reports may be unsolicited. In such a configuration, UEs may periodically perform counting/MBSFN measurements and send counting/MBSFN measurement reports. The period for sending the reports may be specified by the network in dedicated RRC signaling (unicast), in a SIB, or in information transmitted on the MCCH. UEs may perform the measurements based on thresholds. The thresholds may be specified by the network in dedicated RRC signaling, a SIB, or on the MCCH. The counting reports/MBSFN measurement reports may be solicited. Such measurement requests for the MBSFN measurement reports may be received through dedicated RRC signaling, a SIB, or the MCCH. Measurement requests for the counting reports may be received through the MCCH.

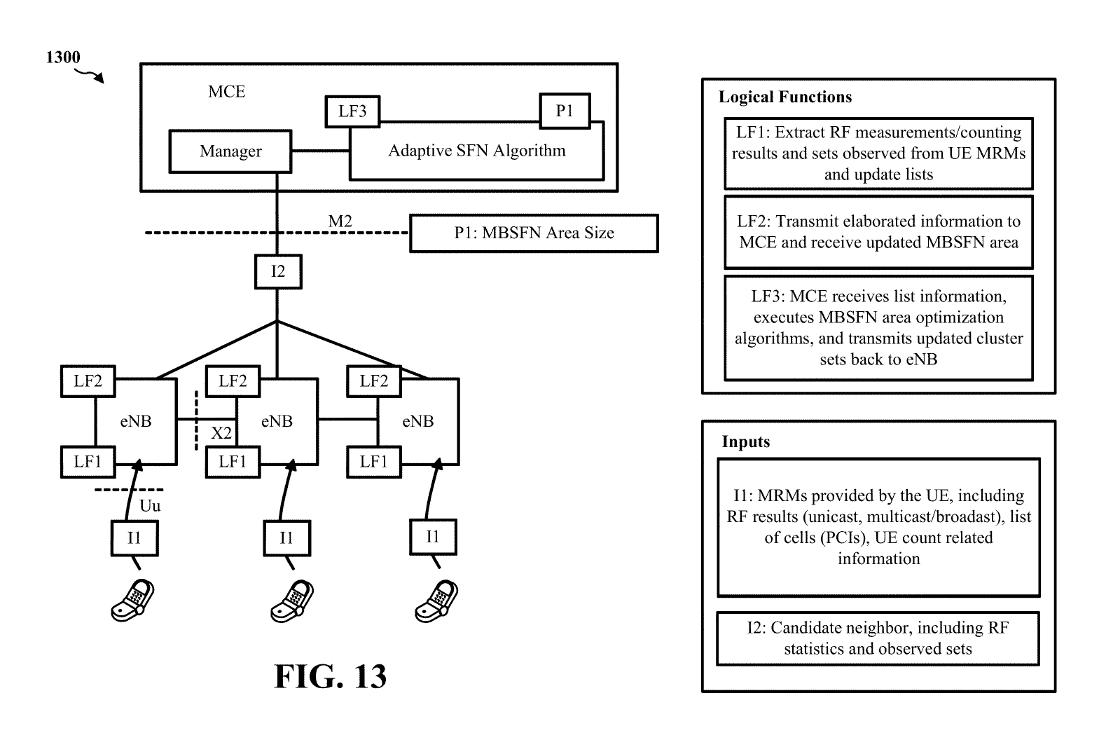

FIG. 13 is a diagram 1300 illustrating a first exemplary algorithm architecture. UEs are instructed by serving eNBs to measure and to report measurement report messages (MRMs) about the serving eNB and surrounding/neighboring eNBs. The UEs may also report on whether they would like to receive MBSFN services or particular MBSFN services. The UEs send the information within the input I1 to the eNBs. The input I1 includes one or more of MRMs, information for obtaining a count of UEs (i.e., UE count information) interested in MBSFN services or particular MBSFN services. The MRMs may include radio frequency (RF) results, such as RSRP, RSRQ, RSSI, SNR, or SINR measurements for unicast transmissions and/or multicast/broadcast transmissions. The MRMs may further include a list of cells (e.g., physical cell identities (PCIs)). The eNBs receive the input I1 from the UEs.

In logical function LF1, the eNBs extract RF measurements, obtain the list of cells, and determine a count of UEs (i.e., UE count information) that would like to receive MBSFN services or particular MBSFN services. The eNBs may then rank the list of cells. In the logical function LF2, the eNBs transmit elaborated information to the MCE and receive an updated configuration for the multicast broadcast service area. The elaborated information may include the RF measurements, list of cells, and the UE count information. Alternatively or additionally, the elaborated information may include the ranked list of cells. The eNBs send input I2 to the MCE. The input I2 includes candidate neighbors, including RF statistics and observed sets. In logical function LF3, the MCE receives the list information, executes MBSFN area optimization algorithms to maximize a goal function for adjusting to the network load and MBMS user distribution, and transmits updated cluster sets (i.e., multicast broadcast service area configuration) back to the eNBs indicating whether the eNBs should be part of the multicast broadcast service area.

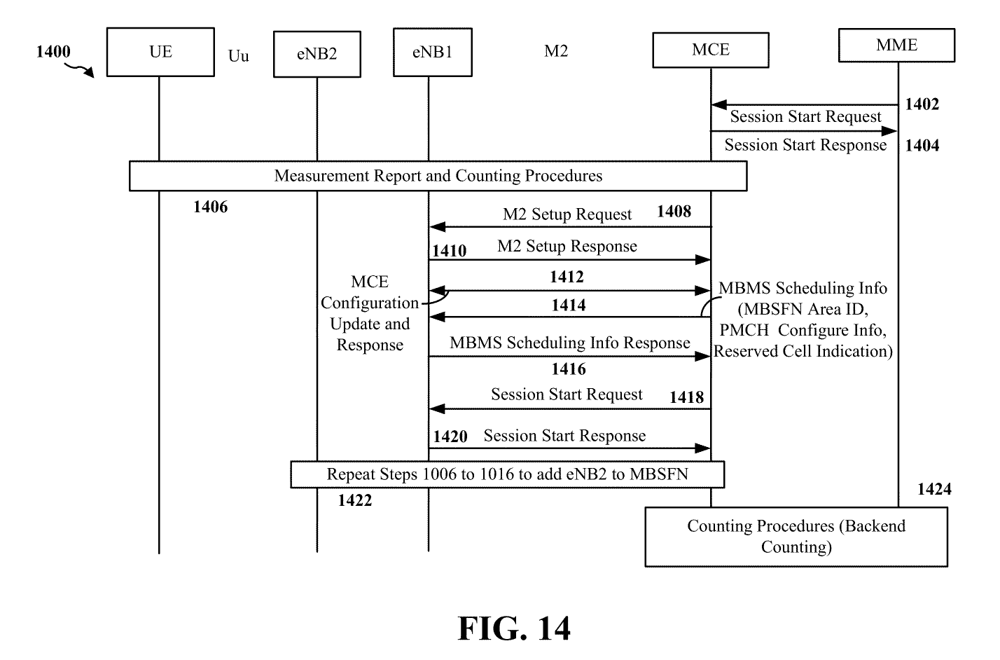

FIG. 14 is a diagram 1400 illustrating a first exemplary signaling design for an adaptive MBSFN. As shown in FIG. 14, in step 1402, the MME sends a session start request to the MCE. In step 1404, the MCE responds by sending a session start response to the MME. In step 1406, the eNB1 obtains UE measurement reports and UE count information indicating a number of UEs served by the eNB1 that are interested in receiving MBSFN services and/or particular MBSFN services, and sends the UE measurement reports and UE count information to the MCE. Based on the received information, the MCE then determines whether particular eNBs should be part of the multicast broadcast service area. In step 1408, the MCE sends an M2 interface setup request to the eNB1. In step 1410, the eNB1 responds by sending an M2 interface setup response to the MCE. In one configuration, step 1406 may follow steps 1408, 1410. In step 1412, the MCE sends an MCE configuration update to the eNB1 and receives an MCE configuration update response from the eNB1. In step 1414, the MCE sends MBMS scheduling information to the eNB1. The MBMS scheduling information may include an MBSFN area identifier (ID), PMCH configuration information, and a reserved cell indication. The MCE may send information, explicitly or implicitly, to the eNB1 indicating an adapted MBSFN configuration in relation to the multicast broadcast service area within the MCE configuration update in step 1412 or the MBMS scheduling information in step 1414. In one configuration, the adaptive MBSFN configuration information may be sent, explicitly or implicitly, within the M2 setup request in step 1408, assuming the measurement report and counting procedures of step 1406 is performed before step 1408. In another configuration, the adaptive MBSFN configuration information may be sent, explicitly or implicitly, within an eNB configuration update acknowledgment. In step 1416, the eNB1 sends an MBMS scheduling information response to the MCE. In step 1418, the MCE sends a session start request to the eNB1. In step 1420, the MCE receives a session start response from the eNB1. In step 1422, the MCE repeats steps 1406 through 1416 with the eNB2. In step 1424, the MCE may receive UE count information from the MME in a backend counting procedure in which UE count information is received from the MME. The MCE may use the UE count information from the eNBs and/or the MME when determining the adaptive MBSFN configuration for each of the adaptively configurable eNBs.

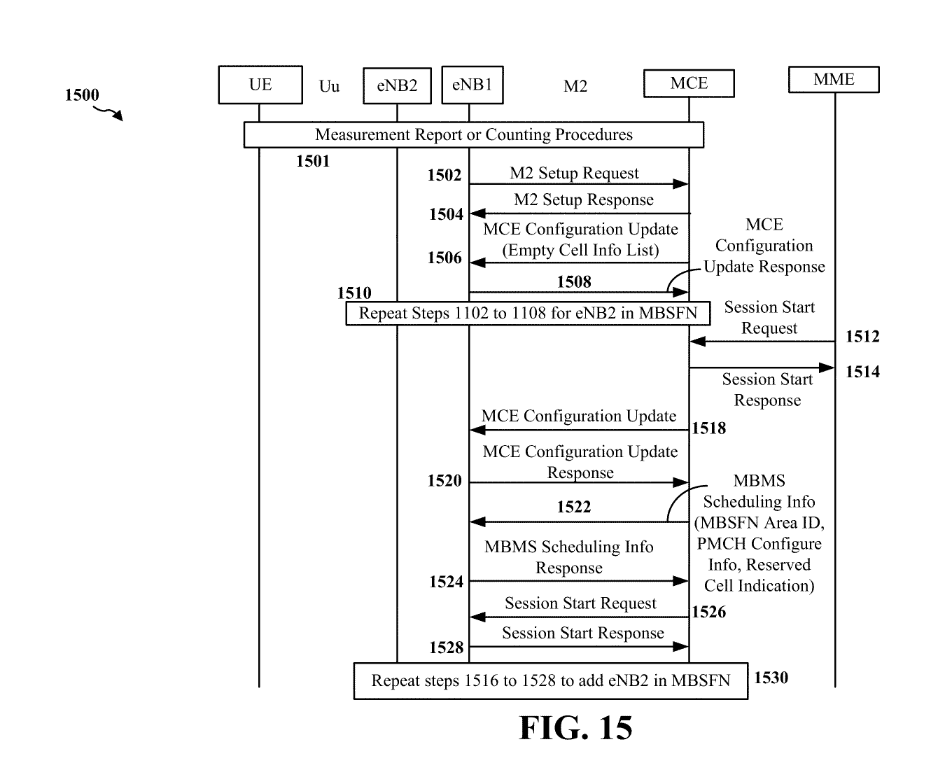

FIG. 15 is a diagram 1500 illustrating a second exemplary signaling design for an adaptive MBSFN. As shown in FIG. 15, in step 1501, the eNB1 and eNB2 obtain UE measurement reports and UE count information indicating a number of UEs served by the eNB1 and eNB2, respectively, that are interested in receiving MBSFN services and/or particular MBSFN services, and send the UE measurement reports and UE count information to the MCE. Based on the received information, the MCE then determines whether particular eNBs should be part of the multicast broadcast service area. In step 1502, the eNB1 sends an M2 interface setup request to the MCE. In step 1504, the MCE responds by sending an M2 interface setup response to the eNB1. In step 1506, the MCE may send an MCE configuration update to the eNB1. The MCE may send the MCE configuration update to the eNB1 with an empty Cell Information List Information Element (IE) if the MCE does not want the eNB1 to send MCCH/MTCH. In step 1508, the eNB1 sends an MCE configuration update response to the MCE. In step 1510, the MCE may repeat steps 1502 to 1508 for the eNB2. In step 1512, the MME sends a session start request to the MCE. In step 1514, the MCE responds by sending a session start response to the MME. In step 1018, the MCE sends an MCE configuration update to the eNB1. The MCE configuration update may change the multicast broadcast service area of the eNB1. In step 1520, the MCE receives an MCE configuration update response from the eNB1. In step 1522, the MCE sends MBMS scheduling information to the eNB1. The MBMS scheduling information may include an MBSFN area ID, PMCH configuration information, and a reserved cell indication.

The MCE may signal to the eNB1 that the eNB1 should not broadcast MCCH/MTCH through the reserved cell indication by informing the eNB1 that it is a reserved cell. In step 1524, the eNB1 sends an MBMS scheduling information response to the MCE. In step 1526, the MCE sends a session start request to the eNB1. In step 1528, the eNB1 sends a session start response to the MCE. In step 1530, the MCE may repeat the steps 1516 to 1528 with the eNB2.

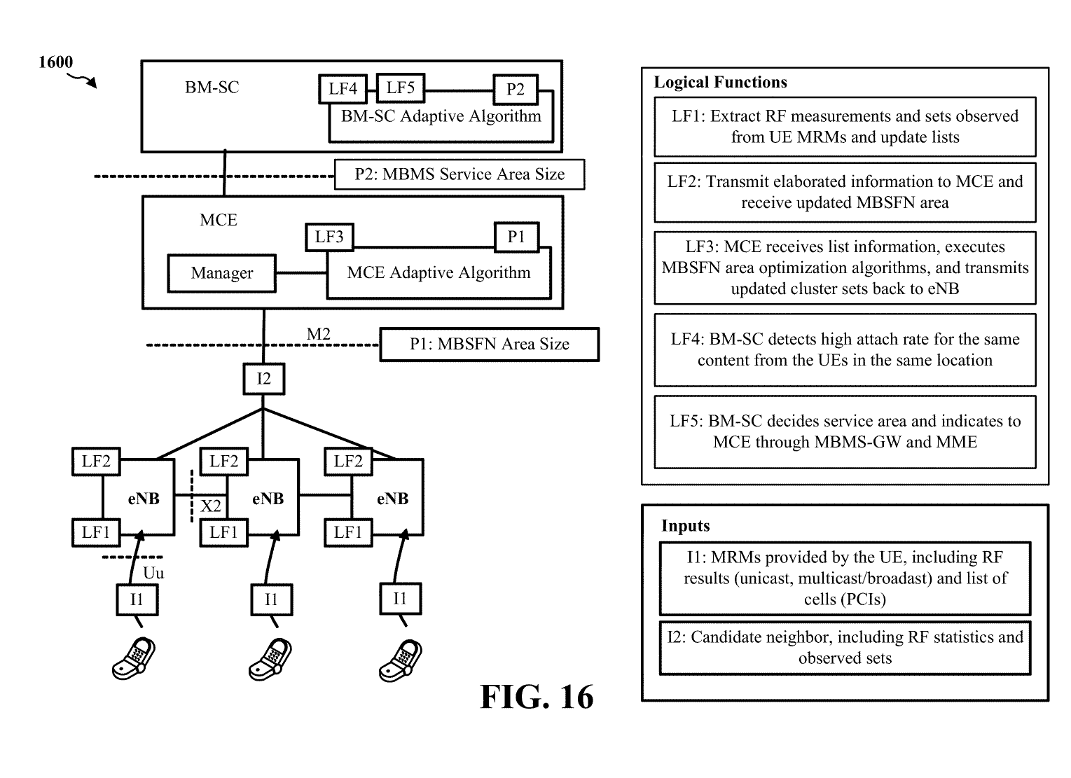

FIG. 16 is a diagram 1600 illustrating a second exemplary algorithm architecture. UEs are instructed by serving eNBs to measure and to send UE measurement reports about the serving eNB and surrounding/neighboring eNBs. The UEs may also report on whether they would like to receive MBSFN services or particular MBSFN services. The UEs send the information within the input I1 to the eNBs. The input I1 includes MRMs, and may further include information for obtaining a count of UEs (i.e., UE count information) interested in MBSFN services or particular MBSFN services. The MRMs include RF results, such as RSRP, RSRQ, RSSI, SNR, or SINR measurements for unicast and/or multicast/broadcast. The MRMs may further include a list of cells (e.g., PCIs). The eNBs receive the input I1 from the UEs.

In logical function LF1, the eNBs extract RF measurements and obtain the list of cells. The eNBs may also determine a count of UEs (i.e., UE count information) that would like to receive MBSFN services or particular MBSFN services. The eNBs may also rank the list of cells. In the logical function LF2, the eNBs transmit elaborated information to the MCE and receive an updated multicast broadcast service area. The elaborated information may include the RF measurements and list of cells. The elaborated information may further include the UE count information. Alternatively or additionally, the elaborated information may include the ranked list of cells if the eNBs rank the cells. The eNBs send input I2 to the MCE. The input I2 includes candidate neighbors, including RF statistics and observed sets. In logical function LF3, the MCE receives the list information, executes MBSFN area optimization algorithms to maximize a goal function for adjusting to the network load and MBMS user distribution, and transmits updated cluster sets (i.e., multicast broadcast service area configuration) back to the eNBs indicating whether the eNBs should be part of the multicast broadcast service area. In logical function LF4, the BM-SC detects a high attach rate for (e.g., receiving, desire to receive) the same content from the UEs in the same location. In logical function LF5, the BM-SC determines the multicast broadcast service area for some eNBs and indicates the MBSFN configuration to the MCE through the MBMS Gateway (MBMS-GW) and MME.

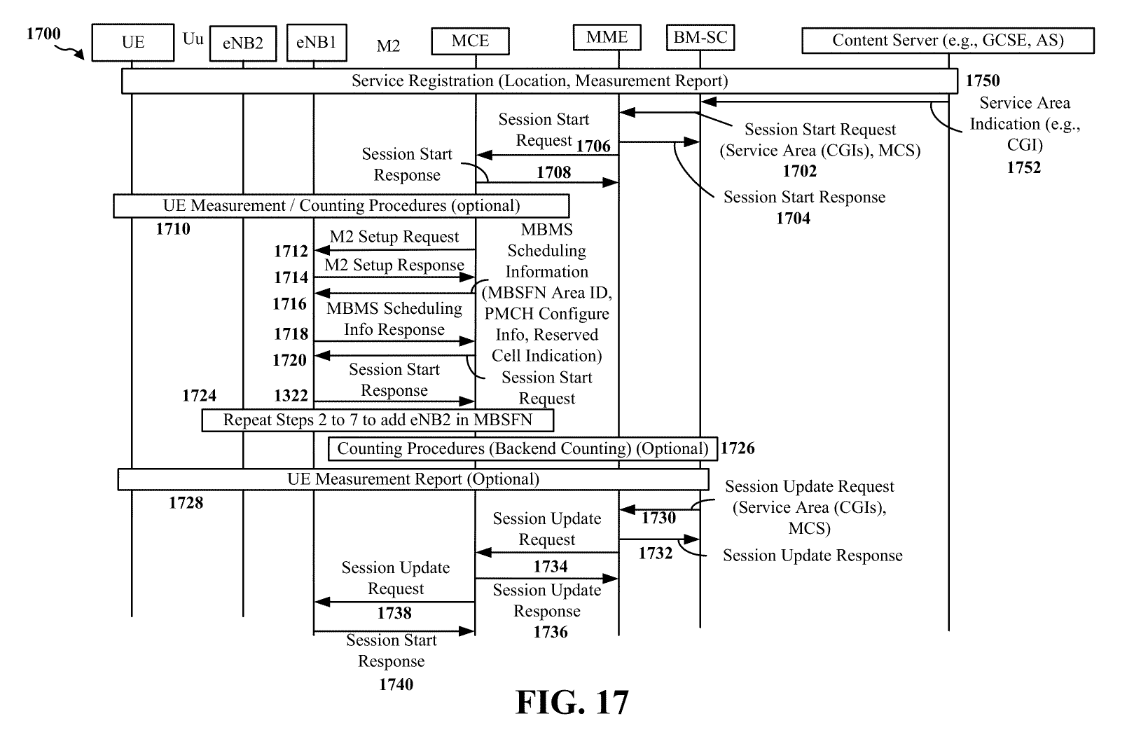

FIG. 17 is a diagram 1700 illustrating a third exemplary signaling design for an adaptive MBSFN. As shown in FIG. 17, in step 1750, a content server (e.g., a GCSE (for group calls) or application server (AS)) performs service registration procedures to obtain UE location information and measurement reports from the UE. The content server determines an MBMS service area based on the UE location information and measurement reports. Based on the UE location information, the content server determines a BM-SC corresponding to the UE. In step 1752, the BM-SC receives a service area indication indicating the determined MBMS service area from the content server. The service area indication may be a cell global identity (CGI) or another service area indication. In step 1702, the BM-SC sends a session start request to the MME. The session start request may include a list of CGIs defining an adaptive MBSFN configuration and an MBSFN configuration, such as MCCH/MTCH configurations (e.g., a modulation and coding scheme (MCS)). In step 1704, the MME sends a session start response to the BM-SC. In step 1706, the MME sends a session start request to the MCE. In step 1708, the MCE responds by sending a session start response to the MME. In step 1710, the MCE may obtain the UE measurement and/or UE count information for the BM-SC. In step 1712, the MCE sends an M2 interface setup request to the eNB1. In step 1714, the eNB1 responds by sending an M2 interface setup response to the MCE. In step 1716, the MCE sends MBMS scheduling information to the eNB1. The MBMS scheduling information may include an MBSFN area ID, PMCH configuration information, and a reserved cell indication. In step 1718, the eNB1 sends an MBMS scheduling information response to the MCE. In step 1720, the MCE sends a session start request to the eNB1. In step 1722, the MCE receives a session start response from the eNB1. In step 1724, the MCE repeats steps 1704 through 1714 with the eNB2. In step 1726, the BM-SC may obtain UE count information (see LF4 of FIG. 12). In step 1728, the BM-SC may also obtain UE measurement reports (unicast and/or multicast/broadcast). Based on the UE count information and the UE measurement reports, the BM-SC may determine an adaptive MBSFN configuration for configuring particular eNBs to be part of the multicast broadcast service area. In step 1730, the BM-SC sends a session update request to the MME. The session update request includes a list of CGIs defining the determined adaptive MBSFN configuration and an MBSFN configuration. In step 1732, the MME sends a session update response to the BM-SC. In step 1734, the MME sends a session update request to the MCE. The session update request includes the adaptive MBSFN configuration. In step 1736, the MCE sends a session update response to the MME. In step 1738, the MCE sends a session update request to the eNB1. The session update request includes the adaptive MBSFN configuration. In step 1740, the eNB1 sends a session start response to the MCE.

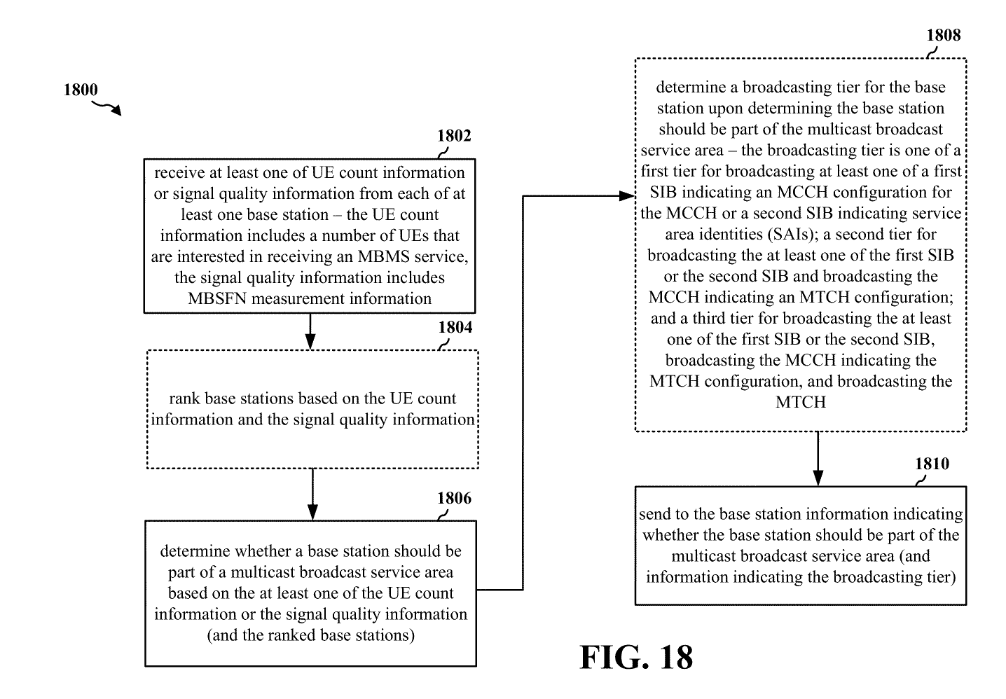

FIG. 18 is a flow chart 1800 of a first method of wireless communication. The method may be performed by a network entity, which may be an eNB and/or MCE, a BM-SC, or another network entity that is accessible by O&M. In step 1802, the network entity receives at least one of UE count information or signal quality information from each of at least one base station. The UE count information includes a number of UEs that are interested in receiving an MBMS service. The signal quality information includes MBSFN measurement information. In step 1804, the network entity may rank base stations based on the at least one of the UE count information or the signal quality information. In step 1806, the network entity may determine whether a base station should be part of a multicast broadcast service area based on the at least one of the UE count information or the signal quality information. As discussed supra, the multicast broadcast service area may include one or more of an MBMS service area, an MBSFN area, an MTCH SFN, or an MCCH SFN. Accordingly, in step 1806, the network entity may determine whether a base station should be part of an MBMS service area, an MBSFN area, an MTCH SFN, and/or an MCCH SFN. If step 1804 is performed, in step 1806, the network entity may determine whether the base station should be part of the multicast broadcast service area further based on the ranked base stations. In step 1808, the network entity may determine a broadcasting tier for the base station upon determining the base station should be part of the multicast broadcast service area. The broadcasting tier is one of a first tier for broadcasting at least one of a first SIB indicating an MCCH configuration for the MCCH and a second SIB indicating SAIs; a second tier for broadcasting the at least one of the first SIB or the second SIB, and broadcasting the MCCH indicating an MTCH configuration; and a third tier for broadcasting the at least one of the first SIB or the second SIB, broadcasting the MCCH indicating the MTCH configuration, and broadcasting the MTCH. If the network entity determines that a base station should belong to the first tier, then the network entity determines that the base station should not be part of the MCCH SFN and the MTCH SFN. If the network entity determines that a base station should belong to the second tier, then the network entity determines that the base station should be part of the MCCH SFN, but not the MTCH SFN. If the network entity determines that a base station should belong to the third tier, then the network entity determines that the base station should be part of the MCCH SFN and the MTCH SFN. The network entity may determine the broadcasting tier based on the at least one of the UE count information or the signal quality information. In step 1810, the network entity sends to the base station information indicating whether the base station should be part of the multicast broadcast service area. If step 1808 is performed, in step 1810, the network entity also sends information to the base station indicates the broadcasting tier.

For example, referring to FIG. 8, a network entity, such as an MCE/BM-SC, may receive UE count information and signal quality information from each of the eNBs 802a, 802b, 802c, 802d, 804a, 804b, 804c, 806a, 808a, and 810a. Based on the UE count information and the signal quality information, the network entity may determine that the eNB 804c should be part of the multicast broadcast service area of the multicast broadcast synchronization area 812. Furthermore, based on the UE count information and the signal quality information, the network entity may determine that the eNB 804c should provide tier 3 844 services.

In step 1802, the UE count information may include at least one of a number of UEs served by each of the at least one base station that are interested in receiving an MBMS service or a number of UEs that indicated an interest in receiving the MBMS service in MBMS interest indication messages. The signal quality information may be with respect to serving base stations and neighboring base stations. The signal quality information may further include unicast measurement information. The unicast measurement information may be based on unicast transmissions, and the unicast measurement information may include at least one of RSRP information, RSRQ information, an RSSI, an SNR, or an SINR. In one configuration, in step 1802, the network entity receives the at least one of the UE count information or the signal quality information by receiving ranked list information, where the ranked list information includes a list of base stations ranked based on the at least one of the UE count information or the signal quality information. In such a configuration, step 1804 is not performed by the network entity. In step 1802, the MBSFN measurement information may be based on muilticast/broadcast transmissions, and the MBSFN measurement information may include at least one of MBSFN RSRP information, MBSFN RSRQ information, an MBSFN RSSI, an MBSFN SNR, or an MBSFN SINR. The at least one base station may include a first set of base stations and a second set of base stations. The first set of base stations may be statically configured to be part of the multicast broadcast service area. The second set of base stations may be adaptively configured to be part of the multicast broadcast service area. The base station may be within the second set of base stations. For example, referring to FIG. 8, the first set of base stations may include the static eNBs, specifically the eNBs 802a, 802b, 802c, 802d. The second set of base stations may include the adaptively configurable eNBs, specifically the eNBs 804a, 804b, 804c. The base station (e.g., eNB 804c) is within the second set of base stations.

In one configuration, the network entity sends an M2 interface setup request to each of the at least one base station, and receives an M2 interface setup response from each of the least one base station. In step 1802, the network entity may receive the UE count information or the signal quality information in response to the M2 interface setup request. For example, referring to FIG. 10, in step 1408 the MCE sends an M2 interface setup request to the eNB1, and in step 1410 receives an M2 interface setup response. The MCE may receive the UE count information or the signal quality information in step 1406 in response to the M2 interface setup request sent in step 1408 (step 1406 may occur after step 1410). In one configuration, the network entity may receive an M2 interface setup request from each of the at least one base station, and send an M2 interface setup response to each of the least one base station. In step 1802, the network entity may receive the UE count information or signal quality information in response to the M2 interface setup request. In step 1810, the information sent to the base station may be exchanged through inter-MCE interfaces. In step 1810, the network entity may send the information the base station implicitly or explicitly within at least one of a M2 Setup Request message, MCE configuration update message, an eNB Configuration Update Acknowledgement, or MBMS scheduling information. In step 1810, the network entity (e.g., see FIGS. 16, 17 in which network entity is BM-SC) may send the information indicating whether the base station should be part of the multicast broadcast service area to an MCE through a list of CGIs. The network entity may determine an MBSFN configuration, and send the MBSFN configuration to the MCE along with the list of CGIs.

In step 1802, the network entity may receive the at least one of the UE count information or the signal quality information in response to a request for the information. Before step 1802, the network entity may send at least one of a period or a threshold for indicating to a UE whether to send the at least one of the UE count information or the signal quality information. The network entity may send the at least one of the period or the threshold to the UE through at least one of RRC signaling, a SIB, or an MCCH.

For example, referring to FIG. 8, the MCE/BM-SC may make the determination to add the eNB 804c to the multicast broadcast service area based on providing MBSFN (MBMS) services for any UEs served by the eNB 804c, such as the UE 826, or based on providing improved (e.g., improved MBSFN RSRP, MBSFN RSRQ, MBSFN RSSI, MBSFN SINR) MBSFN services for any UEs on the cell edge of the eNB 804c, such as for the UEs 820, 822. In step 1810, the apparatus may determine a broadcasting tier for the base station upon determining the base station should be part of the multicast broadcast service area. The broadcasting tier is one of a first tier for broadcasting a SIB indicating an MCCH configuration for the MCCH; a second tier for broadcasting the SIB indicating the MCCH configuration for the MCCH and broadcasting the MCCH indicating an MTCH configuration; and a third tier for broadcasting the SIB indicating the MCCH configuration for the MCCH, broadcasting the MCCH indicating the MTCH configuration, and broadcasting the MTCH. The broadcasting tier is determined based on the UE count information. The broadcasting tier may be further determined based on the signal quality information and/or the ranked base stations. In step 1812, the apparatus sends to the base station information indicating whether the base station should be part of the multicast broadcast service area. The apparatus may further send to the base station information indicating the determined broadcasting tier.

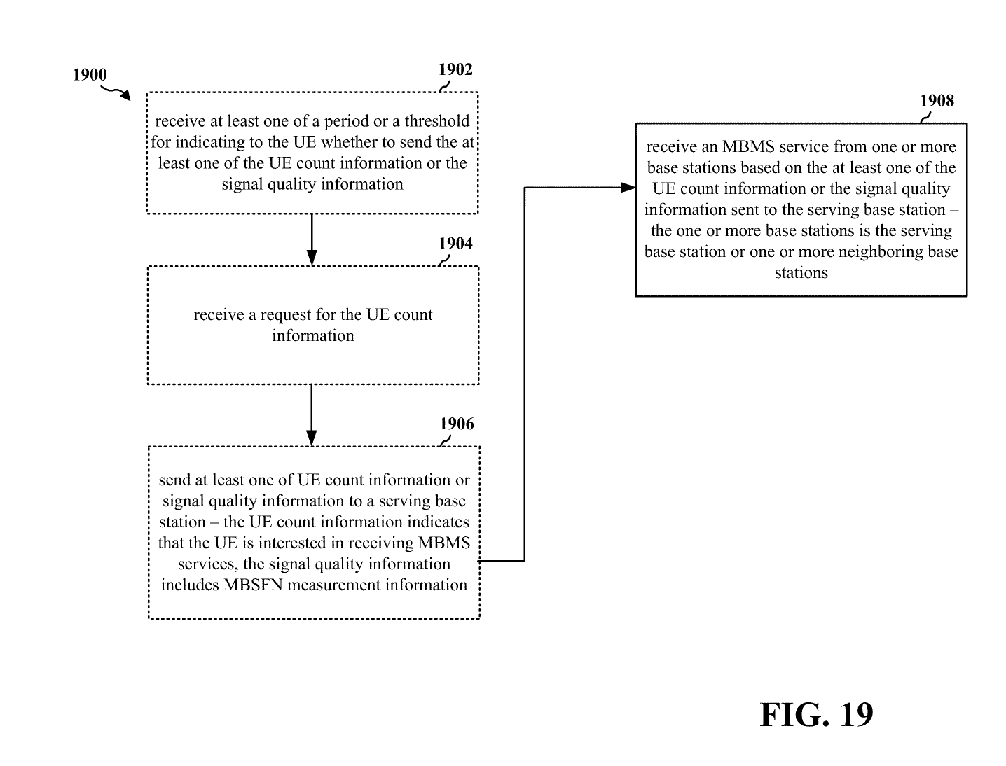

FIG. 19 is a flow chart 1900 of a second method of wireless communication. The method may be performed by a UE. In step 1906, the UE sends at least one of UE count information or signal quality information to a serving base station. The UE count information indicates that the UE is interested in receiving an MBMS service. The signal quality information includes MBSFN measurement information. In step 1908, the UE receives the MBMS service from one or more base stations based on the at least one of the UE count information or the signal quality information sent to the serving base station. The one or more base stations include at least one of the serving base station or one or more neighboring base stations. In step 1906, the UE may send the UE count information in a counting report or an MBMS interest indication message. The signal quality information may be with respect to serving base stations and neighboring base stations. The signal quality information may further include unicast measurement information. The unicast measurement information may be based on unicast transmissions, and the unicast measurement information may include at least one of RSRP information, RSRQ information, an RSSI, an SNR, or an SINR. The MBSFN measurement information may be based on muilticast/broadcast transmissions, and the MBSFN measurement information may include at least one of MBSFN RSRP information, MBSFN RSRQ information, an MBSFN RSSI, an MBSFN SNR, or an MBSFN SINR. In step 1904, the UE may receive a request for the UE count information. In step 1906, the UE may send the UE count information in response to the request received in step 1904. In step 1902, the UE may receive at least one of a period or a threshold for indicating to the UE whether to send the at least one of the UE count information or the signal quality information. The UE may receive the at least one of the period or the threshold through at least one of RRC signaling, a SIB, or an MCCH.

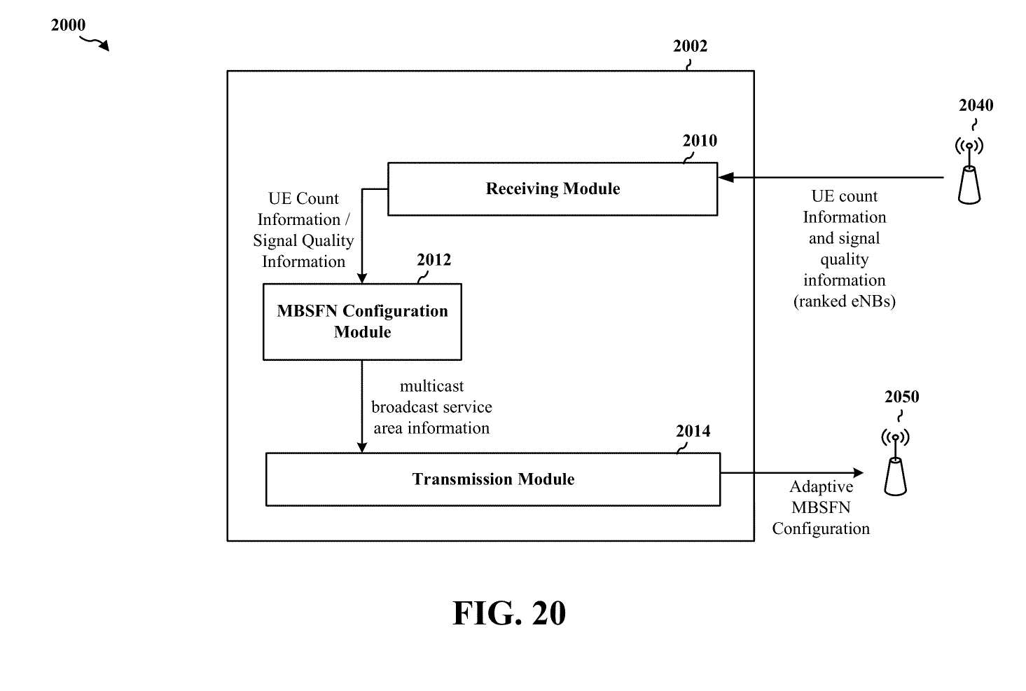

FIG. 20 is a conceptual data flow diagram 2000 illustrating the data flow between different modules/means/components in an exemplary apparatus 2002. The apparatus may be a network entity, such as an MCE, a BM-SC, an eNB, or otherwise a network entity that is accessible by O&M. The apparatus includes a receiving module 2010 that is configured to receive at least one of UE count information or signal quality information from each of at least one base station 2040. The UE count information includes a number of UEs that are interested in receiving an MBMS service. The signal quality information includes MBSFN measurement information. The apparatus further includes an MBSFN configuration module that is configured to determine whether a base station 2050 should be part of a multicast broadcast service area based on the at least one of the UE count information or the signal quality information. The apparatus further includes a transmission module 2014 that is configured to send to the base station 2050 information indicating whether the base station should be part of the multicast broadcast service area.

In one configuration, the UE count information includes at least one of a number of UEs served by each of the at least one base station that are interested in receiving an MBMS service or a number of UEs that indicated an interest in receiving an MBMS service in MBMS interest indication messages. In one configuration, the signal quality information is with respect to serving base stations and neighboring base stations. In one configuration, the signal quality information further includes unicast measurement information. In one configuration, the unicast measurement information is based on unicast transmissions, and the unicast measurement information includes at least one of RSRP information, RSRQ information, an RSSI, an SNR, or an SINR. The MBSFN configuration module 2012 may be configured to rank base stations based on the at least one of the UE count information or the signal quality information. The MBSFN configuration module 2012 may determine whether the base station should be part of the multicast broadcast service area based on the ranked base stations. In one configuration, the receiving module 2010 may receive the at least one of the UE count information or the signal quality information by receiving ranked list information, where the ranked list information includes a list of base stations ranked based on the at least one of the UE count information or the signal quality information. In one configuration, the MBSFN measurement information is based on muilticast/broadcast transmissions, and the MBSFN measurement information includes at least one of MBSFN RSRP information, MBSFN RSRQ information, an MBSFN RSSI, an MBSFN SNR, or an MBSFN SINR.

The at least one base station may include a first set of base stations and a second set of base stations. The first set of base stations may be statically configured to be part of the multicast broadcast service area. The second set of base stations may be adaptively configured to be part of the multicast broadcast service area. The base station may be within the second set of base stations. The transmission module 2014 may be configured to send an M2 interface setup request to each of the at least one base station. The receiving module 2010 may be configured to receive an M2 interface setup response from each of the least one base station. The UE count information or the signal quality information may be received in response to the M2 interface setup request. The receiving module 2010 may be configured to receive an M2 interface setup request from each of the at least one base station. The transmission module 2014 may be configured to send an M2 interface setup response to each of the least one base station. The UE count information or signal quality information may be received in response to the M2 interface setup request. In one configuration, the information sent to the base station is exchanged through inter-MCE interfaces. In one configuration, the information sent to the base station is sent implicitly or explicitly within at least one of a M2 Setup Request message, an MCE configuration update message, an eNB Configuration Update Acknowledgement, or MBMS scheduling information.

The MBSFN configuration module 2012 may be configured to determine a broadcasting tier for the base station upon determining the base station should be part of the multicast broadcast service area, where the broadcasting tier is one of a first tier for broadcasting at least one of a first SIB indicating an MCCH configuration for the MCCH and a second SIB indicating SAIs; a second tier for broadcasting the at least one of the first SIB or the second SIB, and broadcasting the MCCH indicating an MTCH configuration; and a third tier for broadcasting the at least one of the first SIB or the second SIB, broadcasting the MCCH indicating the MTCH configuration, and broadcasting the MTCH. The information sent to the base station further indicates the broadcasting tier. In one configuration, the broadcasting tier is determined based on the at least one of the UE count information or the signal quality information.

When the method is performed by an BM-SC or a network entity that is accessible by O&M, the information indicating whether the base station should be part of the multicast broadcast service area may be sent to an MCE through a list of CGIs. In such a configuration, the MBSFN configuration module 2012 may be configured to determine an MBSFN configuration, and the transmission module 2014 may be configured to send the MBSFN configuration to the MCE along with the list of CGIs. In one configuration, the at least one of the UE count information or the signal quality information is received in response to a request for the information. In one configuration, the transmission module 2014 is configured to send at least one of a period or a threshold for indicating to a UE whether to send the at least one of the UE count information or the signal quality information. The at least one of the period or the threshold may be sent to the UE through at least one of RRC signaling, a SIB, or an MCCH.

The apparatus may include additional modules that perform each of the steps of the algorithm in the aforementioned flow chart of FIG. 18 and any of the diagrams of FIGS. 13-17. As such, each step in the aforementioned flow charts/diagrams may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

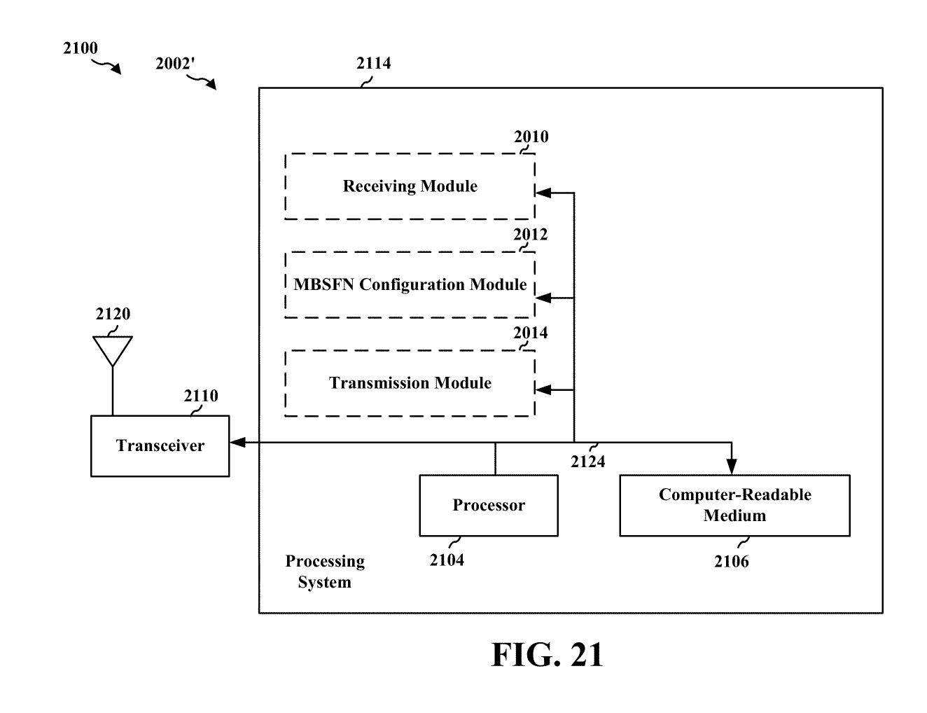

FIG. 21 is a diagram 2100 illustrating an example of a hardware implementation for an apparatus 2002′ employing a processing system 2114. The processing system 2114 may be implemented with a bus architecture, represented generally by the bus 2124. The bus 2124 may include any number of interconnecting buses and bridges depending on the specific application of the processing system 2114 and the overall design constraints. The bus 2124 links together various circuits including one or more processors and/or hardware modules, represented by the processor 2104, the modules 2010, 2012, 2014, and the computer-readable medium/memory 2106. The bus 2124 may also link various other circuits such as timing sources, peripherals, voltage regulators, and power management circuits, which are well known in the art, and therefore, will not be described any further.

The processing system 2114 may be coupled to a transceiver 2110. The transceiver 2110 is coupled to one or more antennas 2120. The transceiver 2110 provides a means for communicating with various other apparatus over a transmission medium. The transceiver 2110 receives a signal from the one or more antennas 2120, extracts information from the received signal, and provides the extracted information to the processing system 2114. In addition, the transceiver 2110 receives information from the processing system 2114, and based on the received information, generates a signal to be applied to the one or more antennas 2120. The processing system 2114 includes a processor 2104 coupled to a computer-readable medium/memory 2106. The processor 2104 is responsible for general processing, including the execution of software stored on the computer-readable medium/memory 2106. The software, when executed by the processor 2104, causes the processing system 2114 to perform the various functions described supra for any particular apparatus. The computer-readable medium/memory 2106 may also be used for storing data that is manipulated by the processor 2104 when executing software. The processing system further includes at least one of the modules 2010, 2012, 2014. The modules may be software modules running in the processor 2104, resident/stored in the computer readable medium/memory 2106, one or more hardware modules coupled to the processor 2104, or some combination thereof.

In one configuration, the apparatus 2002/2002′ for wireless communication includes means for receiving at least one of UE count information or signal quality information from each of at least one base station. The UE count information includes a number of UEs that are interested in receiving MBMS services. The signal quality information includes MBSFN measurement information. The apparatus further includes means for determining whether a base station should be part of a multicast broadcast service area based on the at least one of the UE count information or the signal quality information. The apparatus further includes means for sending to the base station information indicating whether the base station should be part of the multicast broadcast service area. The apparatus may further include means for ranking base stations based on the at least one of the UE count information or the signal quality information. The means for determining whether the base station should be part of the multicast broadcast service area may make the determination further based on the ranked base stations. The means for receiving the at least one of the UE count information or the signal quality information may be configured to receive ranked list information. The ranked list information may include a list of base stations ranked based on the at least one of the UE count information or the signal quality information. The apparatus may further include means for sending an M2 interface setup request to each of the at least one base station, and means for receiving an M2 interface setup response from each of the least one base station. The UE count information or the signal quality information may be received in response to the M2 interface setup request. The apparatus may further include means for receiving an M2 interface setup request from each of the at least one base station, and means for sending an M2 interface setup response to each of the least one base station. The UE count information or signal quality information may be received in response to the M2 interface setup request. The apparatus may further include means for determining a broadcasting tier for the base station upon determining the base station should be part of the multicast broadcast service area. The broadcasting tier may be one of a first tier for broadcasting at least one of a first SIB indicating an MCCH configuration for the MCCH and a second SIB indicating SAIs; a second tier for broadcasting the at least one of the first SIB or the second SIB, and broadcasting the MCCH indicating an MTCH configuration; and a third tier for broadcasting the at least one of the first SIB or the second SIB, broadcasting the MCCH indicating the MTCH configuration, and broadcasting the MTCH. The information sent to the base station may further indicate the broadcasting tier. The apparatus may further include means for determining an MBSFN configuration, and means for sending the MBSFN configuration to the MCE along with the list of CGIs. The apparatus may further include means for sending at least one of a period or a threshold for indicating to a UE whether to send the at least one of the UE count information or the signal quality information. The aforementioned means may be one or more of the aforementioned modules of the apparatus 2002 and/or the processing system 2114 of the apparatus 2002′ configured to perform the functions recited by the aforementioned means.

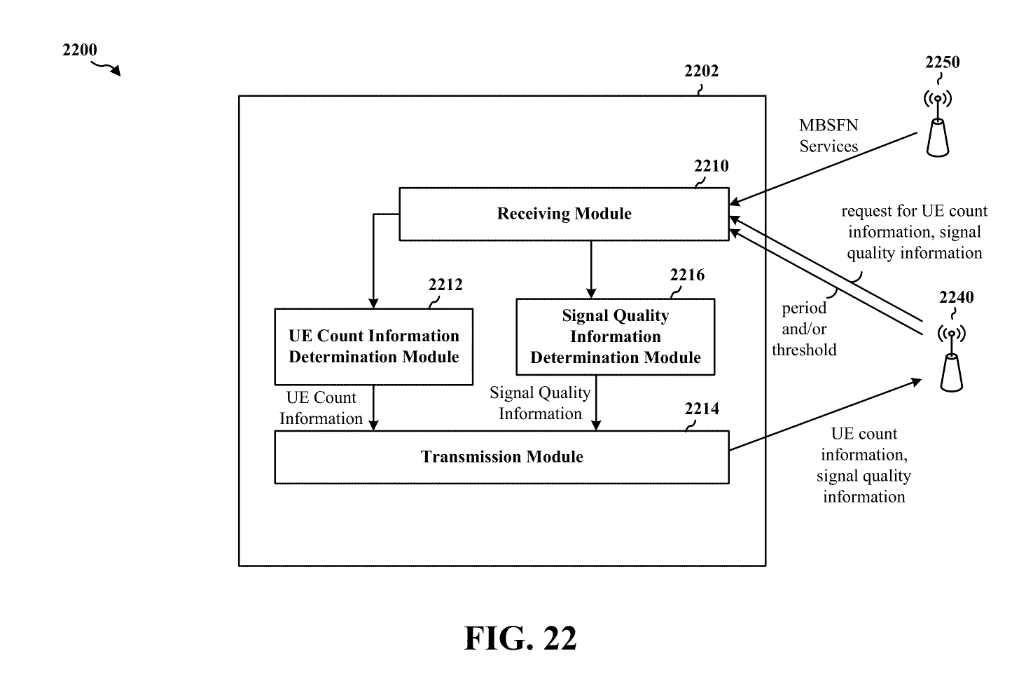

FIG. 22 is a conceptual data flow diagram 2200 illustrating the data flow between different modules/means/components in an exemplary apparatus 2202. The apparatus may be a UE. The UE includes a transmission module 2214 that is configured to send at least one of UE count information or signal quality information to a serving base station 2240. The UE count information indicates that the UE is interested in receiving MBMS services. The signal quality information includes MBSFN measurement information. The transmission module 2214 obtains the UE count information and the signal quality information from the UE count information determination module 2212 and the signal quality information determination module 2216. The UE further includes a receiving module 2210 that is configured to receive MBMS services from one or more base stations based on the at least one of the UE count information or the signal quality information sent to the serving base station 2240. The one or more base stations include at least one of the serving base station 2240 and/or one or more neighboring base stations 2250. The UE may send the UE count information in a counting report or an MBMS interest indication message. The signal quality information may be with respect to serving base stations and neighboring base stations. The signal quality information may further include unicast measurement information. The unicast measurement information may be based on unicast transmissions, and the unicast measurement information may include at least one of RSRP information, RSRQ information, an RSSI, an SNR, or an SINR. The MBSFN measurement information may be based on muilticast/broadcast transmissions, and the MBSFN measurement information may include at least one of MBSFN RSRP information, MBSFN RSRQ information, an MBSFN RSSI, an MBSFN SNR, or an MBSFN SINR. The receiving module 2210 may be further configured to receive a request for the UE count information. The transmission module 2214 may be configured to send the UE count information in response to the request. The receiving module 2210 may be configured to receive at least one of a period or a threshold for indicating to the UE whether to send the at least one of the UE count information or the signal quality information. The UE may receive the at least one of the period or the threshold through at least one of RRC signaling, a SIB, or an MCCH.

The apparatus may include additional modules that perform each of the steps of the algorithm in the aforementioned flow charts of FIG. 19 and any of the diagrams of FIGS. 13-17. As such, each step in the aforementioned flow charts/diagrams may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

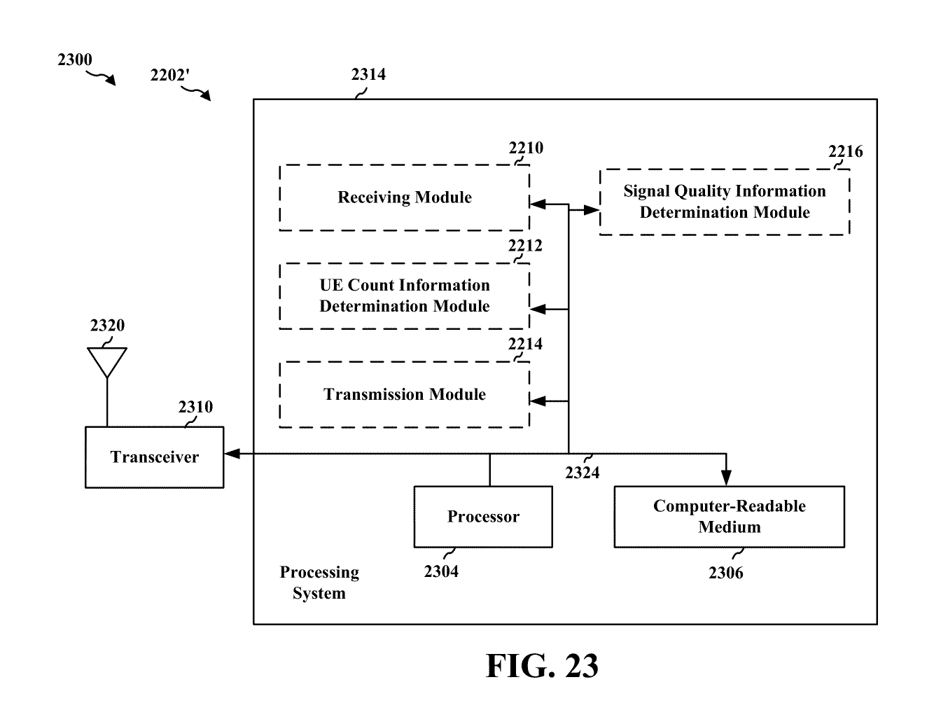

FIG. 23 is a diagram 2300 illustrating an example of a hardware implementation for an apparatus 2202′ employing a processing system 2314. The processing system 2314 may be implemented with a bus architecture, represented generally by the bus 2324. The bus 2324 may include any number of interconnecting buses and bridges depending on the specific application of the processing system 2314 and the overall design constraints. The bus 2324 links together various circuits including one or more processors and/or hardware modules, represented by the processor 2304, the modules 2210, 2212, 2214, and the computer-readable medium/memory 2306. The bus 2324 may also link various other circuits such as timing sources, peripherals, voltage regulators, and power management circuits, which are well known in the art, and therefore, will not be described any further.

The processing system 2314 may be coupled to a transceiver 2310. The transceiver 2310 is coupled to one or more antennas 2320. The transceiver 2310 provides a means for communicating with various other apparatus over a transmission medium. The transceiver 2310 receives a signal from the one or more antennas 2320, extracts information from the received signal, and provides the extracted information to the processing system 2314. In addition, the transceiver 2310 receives information from the processing system 2314, and based on the received information, generates a signal to be applied to the one or more antennas 2320. The processing system 2314 includes a processor 2304 coupled to a computer-readable medium/memory 2306. The processor 2304 is responsible for general processing, including the execution of software stored on the computer-readable medium/memory 2306. The software, when executed by the processor 2304, causes the processing system 2314 to perform the various functions described supra for any particular apparatus. The computer-readable medium/memory 2306 may also be used for storing data that is manipulated by the processor 2304 when executing software. The processing system further includes at least one of the modules 2210, 2212, 2214. The modules may be software modules running in the processor 2304, resident/stored in the computer readable medium/memory 2306, one or more hardware modules coupled to the processor 2304, or some combination thereof. The processing system 2314 may be a component of the eNB 610 and may include the memory 676 and/or at least one of the TX processor 616, the RX processor 670, and the controller/processor 675.

In one configuration, the apparatus 2202/2202′ for wireless communication is a UE and includes means for sending at least one of UE count information or signal quality information to a serving base station. The UE count information indicates that the UE is interested in receiving MBMS services. The signal quality information includes MBSFN measurement information. The apparatus further includes means for receiving MBMS services from one or more base stations based on the at least one of the UE count information or the signal quality information sent to a serving base station. The one or more base stations include at least one of the serving base station or one or more neighboring base stations. The apparatus may further include means for receiving a request for the UE count information. The UE count information may be sent in response to the request. The apparatus may further include means for receiving at least one of a period or a threshold for indicating to the UE whether to send the at least one of the UE count information or the signal quality information. The aforementioned means may be one or more of the aforementioned modules of the apparatus 2202 and/or the processing system 2314 of the apparatus 2202′ configured to perform the functions recited by the aforementioned means. As described supra, the processing system 2314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving at least one of user equipment (UE) count information or signal quality information from each of at least one base station, the UE count information including a number of UEs that are interested in receiving a multimedia broadcast multicast services (MBMS) service, the signal quality information comprising multicast broadcast single frequency network (MBSFN) measurement information;
determining whether a base station should be part of a multicast broadcast service area based on the at least one of the UE count information or the signal quality information; and
sending to the base station information indicating whether the base station should be part of the multicast broadcast service area.

2. The method of claim 1, wherein the UE count information includes at least one of a number of UEs served by each of the at least one base station that are interested in receiving an MBMS service or a number of UEs that indicated an interest in receiving the MBMS service in MBMS interest indication messages.

3. The method of claim 1, wherein the signal quality information is with respect to serving base stations and neighboring base stations.

4. The method of claim 3, wherein the signal quality information further comprises unicast measurement information.

5. The method of claim 4, wherein the unicast measurement information is based on unicast transmissions, and the unicast measurement information comprises at least one of reference signal received power (RSRP) information, reference signal received quality (RSRQ) information, a receive strength signal indicator (RSSI), a signal to noise ratio (SNR), or a signal to interference plus noise ratio (SINR).

6. The method of claim 1, further comprising ranking base stations based on the at least one of the UE count information or the signal quality information, wherein the determining whether the base station should be part of the multicast broadcast service area is further based on the ranked base stations.

7. The method of claim 1, wherein the receiving the at least one of the UE count information or the signal quality information comprises receiving ranked list information, the ranked list information comprising a list of base stations ranked based on the at least one of the UE count information or the signal quality information.

8. The method of claim 1, wherein the MBSFN measurement information is based on muilticast/broadcast transmissions, and the MBSFN measurement information comprises at least one of MBSFN reference signal received power (RSRP) information, MBSFN reference signal received quality (RSRQ) information, an MBSFN receive strength signal indicator (RSSI), an MBSFN signal to noise ratio (SNR), or an MBSFN signal to interference plus noise ratio (SINR).

9. The method of claim 1, wherein the at least one base station comprises a first set of base stations and a second set of base stations, the first set of base stations being statically configured to be part of the multicast broadcast service area, the second set of base stations being adaptively configured to be part of the multicast broadcast service area, the base station being within the second set of base stations.

10. The method of claim 1, further comprising:
sending an M2 interface setup request to each of the at least one base station; and
receiving an M2 interface setup response from each of the least one base station,
wherein the UE count information or the signal quality information is received in response to the M2 interface setup request.

11. The method of claim 1, further comprising:
receiving an M2 interface setup request from each of the at least one base station; and
sending an M2 interface setup response to each of the least one base station,
wherein the UE count information or signal quality information is received in response to the M2 interface setup request.

12. The method of claim 1, wherein the information sent to the base station is exchanged through inter-Multicast Coordination Entity (MCE) interfaces.

13. The method of claim 1, wherein the information sent to the base station is sent implicitly or explicitly within at least one of a M2 Setup Request message, a Multicast Coordination Entity (MCE) configuration update message, an eNB Configuration Update Acknowledgement, or Multimedia Broadcast Multicast Service (MBMS) scheduling information.

14. The method of claim 1, further comprising determining a broadcasting tier for the base station upon determining the base station should be part of the multicast broadcast service area, wherein the broadcasting tier is one of a first tier for broadcasting at least one of a first system information block (SIB) indicating a multicast control channel (MCCH) configuration for the MCCH and a second SIB indicating service area identities (SAIs); a second tier for broadcasting the at least one of the first SIB or the second SIB, and broadcasting the MCCH indicating a multicast traffic channel (MTCH) configuration; and a third tier for broadcasting the at least one of the first SIB or the second SIB, broadcasting the MCCH indicating the MTCH configuration, and broadcasting the MTCH, wherein the information sent to the base station further indicates the broadcasting tier.

15. The method of claim 14, wherein the broadcasting tier is determined based on the at least one of the UE count information or the signal quality information.

16. The method of claim 1, wherein the method is performed by a Broadcast Multicast Service Center (BM-SC) or a network entity that is accessible by Operation and Maintenance (O&M).

17. The method of claim 16, wherein the information indicating whether the base station should be part of the multicast broadcast service area is sent to a Multicast Coordination Entity (MCE) through a list of Cell Global Identities (CGIs).

18. The method of claim 17, further comprising:
determining an MBSFN configuration; and
sending the MBSFN configuration to the MCE along with the list of CGIs.

19. The method of claim 1, wherein the method is performed by at least one of an evolved Node B (eNB) or Multicast Coordination Entity (MCE).

20. The method of claim 1, wherein the at least one of the UE count information or the signal quality information is received in response to a request for the information.

21. The method of claim 1, further comprising sending at least one of a period or a threshold for indicating to a UE whether to send the at least one of the UE count information or the signal quality information.

22. The method of claim 21, wherein the at least one of the period or the threshold is sent to the UE through at least one of radio resource control (RRC) signaling, a system information block (SIB), or a multicast control channel (MCCH).

23. An apparatus for wireless communication, comprising:
means for receiving at least one of user equipment (UE) count information or signal quality information from each of at least one base station, the UE count information including a number of UEs that are interested in receiving a multimedia broadcast multicast services (MBMS) service, the signal quality information comprising multicast broadcast single frequency network (MBSFN) measurement information;
means for determining whether a base station should be part of a multicast broadcast service area based on the at least one of the UE count information or the signal quality information; and
means for sending to the base station information indicating whether the base station should be part of the multicast broadcast service area.

24. The apparatus of claim 23, wherein the UE count information includes at least one of a number of UEs served by each of the at least one base station that are interested in receiving an MBMS service or a number of UEs that indicated an interest in receiving the MBMS service in MBMS interest indication messages.

25. The apparatus of claim 23, wherein the signal quality information is with respect to serving base stations and neighboring base stations.

26. The apparatus of claim 23, further comprising means for ranking base stations based on the at least one of the UE count information or the signal quality information, wherein the means for determining whether the base station should be part of the multicast broadcast service area makes the determination further based on the ranked base stations.

27. The apparatus of claim 23, wherein the means for receiving the at least one of the UE count information or the signal quality information is configured to receive ranked list information, the ranked list information comprising a list of base stations ranked based on the at least one of the UE count information or the signal quality information.

28. The apparatus of claim 23, wherein the MBSFN measurement information is based on muilticast/broadcast transmissions, and the MBSFN measurement information comprises at least one of MBSFN reference signal received power (RSRP) information, MBSFN reference signal received quality (RSRQ) information, an MBSFN receive strength signal indicator (RSSI), an MBSFN signal to noise ratio (SNR), or an MBSFN signal to interference plus noise ratio (SINR).

29. An apparatus for wireless communication, comprising:
a memory; and
at least one processor coupled to the memory and configured to:
receive at least one of user equipment (UE) count information or signal quality information from each of at least one base station, the UE count information including a number of UEs that are interested in receiving a multimedia broadcast multicast services (MBMS) service, the signal quality information comprising multicast broadcast single frequency network (MBSFN) measurement information;
determine whether a base station should be part of a multicast broadcast service area based on the at least one of the UE count information or the signal quality information; and
send to the base station information indicating whether the base station should be part of the multicast broadcast service area.

30. A computer program product stored on a computer-readable medium and comprising code that when executed on at least one processor causes the at least one processor to:
receive at least one of user equipment (UE) count information or signal quality information from each of at least one base station, the UE count information including a number of UEs that are interested in receiving a multimedia broadcast multicast services (MBMS) service, the signal quality information comprising multicast broadcast single frequency network (MBSFN) measurement information;
determine whether a base station should be part of a multicast broadcast service area based on the at least one of the UE count information or the signal quality information; and
send to the base station information indicating whether the base station should be part of the multicast broadcast service area.
